(19) United States
(12) Patent Application Publication
(10) Pub. No.: US 2014/0172783 A1
(43) Pub. Date: Jun. 19, 2014

(54) SYSTEM AND METHOD FOR PROVIDING COMPUTING ENVIRONMENT DELIVERY SERVICE WITH OFFLINE OPERATIONS

(71) Applicant: Prowess Consulting, LLC, Seattle, WA (US)

(72) Inventors: Aaron SUZUKI, Mercer Island, WA (US); Spencer Bradford Dunford, Renton, WA (US)

(73) Assignee: Prowess Consulting, LLC, Seattle, WA (US)

(21) Appl. No.: 14/109,897

(22) Filed: Dec. 17, 2013

Related U.S. Application Data
(60) Provisional application No. 61/738,048, filed on Dec. 17, 2012.

(51) Int. Cl. G06F 17/30

(52) U.S. Cl. CPC G06F 17/30699
USPC 707/609; 707/754; 707/747

(57) ABSTRACT

Systems and methods are presented to provide computing environment delivery service with offline operations. The systems and methods presented may provide a cloud based device management and provisioning system that may be by design both hardware and operating system agnostic. The systems and methods may deliver a base file system to a client device over a computer network, queue data items necessary for additional computing functions by priority, and stream the data necessary for additional computing functions to the client device according to the queue.

### FIELD OF THE DISCLOSURE

The present disclosure relates to systems and methods of computing environment delivery service with offline operations.

### BACKGROUND OF THE DISCLOSURE

Virtual machine technology provides many benefits for businesses. However, because a virtual machine encapsulates an entire computer, use of virtual machines poses significant challenges due to its requirement for large amounts of data storage. The large storage requirements for virtual machines also make transporting virtual machines difficult. It should be noted that the challenge of maintaining computer system images only increases with company scale, particularly with organizations that maintain several computer system images and use a broad number of personal computer and server hardware models.

Conventional single, one-size-fits-all computer system images include many hardware files that may not be used by some or most of the target computers, and hence deploying such a one-size-fits-all system image may be wasteful of time, space, bandwidth, and/or other resources.

Another problem associated with system imaging is the large size of the images. Various conventional solutions have been proposed that take steps to make an image smaller. Creating a single large system image introduces a number of challenges. Because the system image must contain the software required for the majority of end users throughout a company, the system image may be very large. Such a large system image may have adverse effects on storage and network infrastructure. Such a large image may also require significant ongoing maintenance due to the large list of software the system image contains. A single system image also represents a single point of failure, where a flaw could be replicated to all end users.

Creating several smaller system images based on end user geography, organization, or job role may alleviate some of the issues associated with fewer or single large system images. However, creating several smaller system images also introduces duplication of content both stored and distributed within a company network. Even conventional imaging methods that contain a single instance of common files within a system image file represent duplication and additional storage overhead when stored in more than one location.

Physical images are extremely difficult to manage from an enterprise perspective. Updating clients that were installed from physical images are quickly outdated and often hard to track and update. These and other drawbacks exist.

### SUMMARY OF THE DISCLOSURE

The methods and systems disclosed in the present application describe modularizing an image and storing various components of the image on a central server. With this configuration, images (i.e., a software replica of a computer) may be created with reference to known images. This decreases the amount of data in each image. The process of creating software images from a computer's contents may be described as the “capture” process. Once captured, the software images may be deployed (i.e., run on a different machine) more efficiently and easily as opposed to using conventional media containing a large monolithic system image file. Using the systems and methods for capturing and organizing software images described herein, deployment may be accomplished with a much smaller file that may be emailed, downloaded, or linked to. Any organization implementing the system in accordance with exemplary embodiments disclosed herein may achieve substantial savings in terms of time, bandwidth, and administrative complexity when managing and distributing computer system images to one or more target computers.

In an example embodiment, systems and methods may perform the process of optimizing software images by identifying and removing system-unique files including, but not limited to, registry hive files, system state files, and/or log files. Example systems and methods may perform the process of optimizing software images by identifying and removing system-unique metadata, including, but not limited to, file security (i.e., access control lists), file attributes, file names, and/or file path information.

The various embodiments described herein provide advantageous solutions to various problems known to exist with conventional images. For example, in a business or other setting it might be necessary for a laptop to be imaged so that the exact contents of the laptop could be reproduced and deployed on another computer at another location. Conventional systems would create a system image that was an exact picture of the laptop, but the image might be large and not organized in a manner different from the organization of captured laptop. The large system image would then be physically sent on a disk, or possibly hosted on a website where it could then be downloaded, and restored using the same utility that captured the large image. This type of conventional capture-and-deploy scenario uses a tool that creates a system image and the same tool is then used to deploy the system image on a remote computer.

In embodiments of the present disclosure, the capture imaging process involves systems and methods where the computer's relevant files are selectively captured and organized in unique configurations as software images that are different from the configuration employed by the computer. Once captured, the software images may be stored in conventional formats or in a repository of software images maintained on a web server. The software images may then be deployed using proprietary systems and/or methods that recognize the selected and organized software images captured from the laptop and deploy the software images onto another remote computer, such that the remote computer represents a copy of the original laptop. This allows the laptop to be imaged in ways described in various embodiments in order to determine, for example, what aspects of the laptop are already stored in the library of programs, and what aspects are unique to that laptop. Using the systems and methods described herein, one may generate a representation of the laptop using software images that are much smaller than a system image of the laptop captured in the conventional manner.

Furthermore, not only is system image size reduced, an effective way for improved payload efficiency during transport may be provided. Using a combination of smaller system images and conventional software installation processes, an optimal balance of storage and network utilization may be achieved.

The systems and methods described in various embodiments of this disclosure take a different approach than simply creating methods for reducing image size. The systems and methods described herein selectively create software images and organize (and reorganize) those software images in new advantageous ways. For example, virtual machines may be used by companies that want to distribute their virtual machines to many different employees located throughout the world. To deploy a virtual machine to different employees located throughout the world, a company could utilize the systems and methods described herein to generate and then distribute smaller, web-based installation packages containing a deployment engine and system image that reference the software image library. For example, if a virtual machine contained, for example, Microsoft Windows and Office, that virtual machine could be run through a special process which compared the virtual machine to the software image library—which may be accessible worldwide via the internet. This process may generate a small system image that would only have the unique files that were part of a particular demo that the virtual machine was created to run. This small file could be linked back to the customer who could provide the link to all of their employees that need to install this demo on their machine.

The employees may then click on the link to download that small version of the file. In embodiments of the present disclosure, the file may include instructions on how to put the virtual machine back together by referring to the software image that has already been replicated and stored on an accessible network. The advantage of such “smart” and “selective” deployment may be an increase level of efficiency in distributing virtual machines.

The system in accordance with example embodiments may detect what hardware files are used by particular target computers or particular users and may deploy the hardware files used by particular target computers or users. This advantageously does not burden the base system image with hardware files that are used by only a subset of the target computers or users. Moreover, the system in accordance with example embodiments advantageously uses the image module to separate the base system image from the hardware files. Updates to the hardware files may be made and an update image module may be distributed without involving redistributing the base system image to all target computers. Likewise, the base system image may be updated with involving redistribution of the image module. This separation results in savings in terms of time, bandwidth, and administrative complexity for any organization that approaches deployment of base system images as described herein.

The systems and methods may provide user state migration capabilities as well as Operating System and application management. The systems and methods may provide operating system migration capabilities. The systems and methods may provide end point device management from a centralized cloud based location. The systems and methods may provide fast and efficient migrations with a goal of getting the user reengaged in work in approximately 10 minutes or less with minimum applications of email and browser. The systems and methods may attempt to reduce cloud storage and bandwidth utilization as much as possible in an effort to minimize cloud services related costs. The systems and methods interfaces and process may be developed in such a way that it may be extremely easy for administrators and users to manage, migrate, and restore devices. The systems and methods may provide remote mobile access, system management capabilities, and file retrieval functionality

The disclosed computing environment delivery service may provide a powerful desktop management system that may be extremely simple to use and administer. Additionally, the disclosed computing environment delivery service may provide a powerful desktop management system that may be extremely simple to use and administer. Furthermore, the disclosed computing environment delivery service system may execute reliability for the user. The product may run stably with all the documented features mentioned herein.

The computing environment delivery service system may provide simple and intuitive user interfaces that perform all required functions and reports for all role user types, and help documents and online help may be provided and easily accessible.

In an example embodiment, the system may provide a hosted service with layers swappable on the fly, serving to host and/or manage a desktop running locally on a client machine. For example and not by way of limitation, the systems and methods may provide the functionality of streaming a desktop and/or operating system with the minimum number of files, and subsequently add files for additional functionality, applications, and data accessibility.

In an example embodiment, the systems and methods may deliver and/or stream a file system over a network with a file filter driver. The file system may provide a user with a basic environment necessary to perform basic computer functions on an end device. The systems and methods may preform layering, such as de-duplication or other functions. Once the file system is deployed, the systems and methods may distribute additional files to a user or target computer based on priority, user profile attributes, or a user's prior actions or use. Priority to a user may constitute a variety of scenarios. For example and not by way of limitation, the system may deliver and/or stream files over a network according to expected future need based on a user's prior actions or use. For example and not by way of limitation, after the base file system is sent, the systems and methods may send the most frequently used applications, pictures, data, and the like. Additionally, the systems and methods may manage a queue of pending files, and the like to be sent. If a user explicitly requests an action, file, application, and the like, the systems and methods may add the files, data, and the like, necessary for that request to the top of the queue. The systems and methods may also use peer to peer file transfers, or any other type of file transfer, to stream and/or deliver the necessary information.

In an example embodiment, the systems and methods may present a file system and information to a user indicating that files, data, etc. are present that are not yet present on the system. The files shown may be files currently in the queue or files otherwise available to be queued. By doing so, the systems and methods may optionally present a complete, or more complete, desktop to a user when only the files and data necessary for basic computing function are present, while streaming the remaining items necessary for additional functions, media, and the like, unbeknownst to the user. The systems and methods may also provide constant two-way synchronization between devices.

In an example embodiment, the system and methods may manage target system storage based on usage, user requests, operating system requests, and/or application requests. For example, a client agent may mark offline and remove one or more local files of the lowest usage and/or priority if necessary to reclaim enough space for the requested file(s). Removed files can be seamlessly requested and downloaded again if and/or when needed.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 illustrates a system for storing and distributing computer files, in accordance with various exemplary embodiments;

FIG. 2 illustrates a system for storing and distributing computer files, in accordance with an exemplary embodiment;

FIG. 3 illustrates a virtual machine module for storing and distributing computer files, in accordance with exemplary embodiments;

FIG. 4 illustrates a modular system imaging format, in accordance with an exemplary embodiment;

FIG. 5 illustrates a file representation format for the modular system imaging format of FIG. 4, in accordance with an exemplary embodiment;

FIG. 6 illustrates a modular system imaging format, in accordance with another exemplary embodiment;

FIG. 7 illustrates a file representation format for the modular system imaging format of FIG. 6, in accordance with an exemplary embodiment;

FIG. 8 illustrates a modular system imaging format, in accordance with another exemplary embodiment;

FIG. 9 illustrates a file representation format for the modular system imaging format of FIG. 8, in accordance with an exemplary embodiment;

FIG. 10 illustrates an illustrative flow of a method for storing and distributing computer files, in accordance with an exemplary embodiment.

FIG. 11 depicts an exemplary embodiment of computing environment delivery service with offline operations;

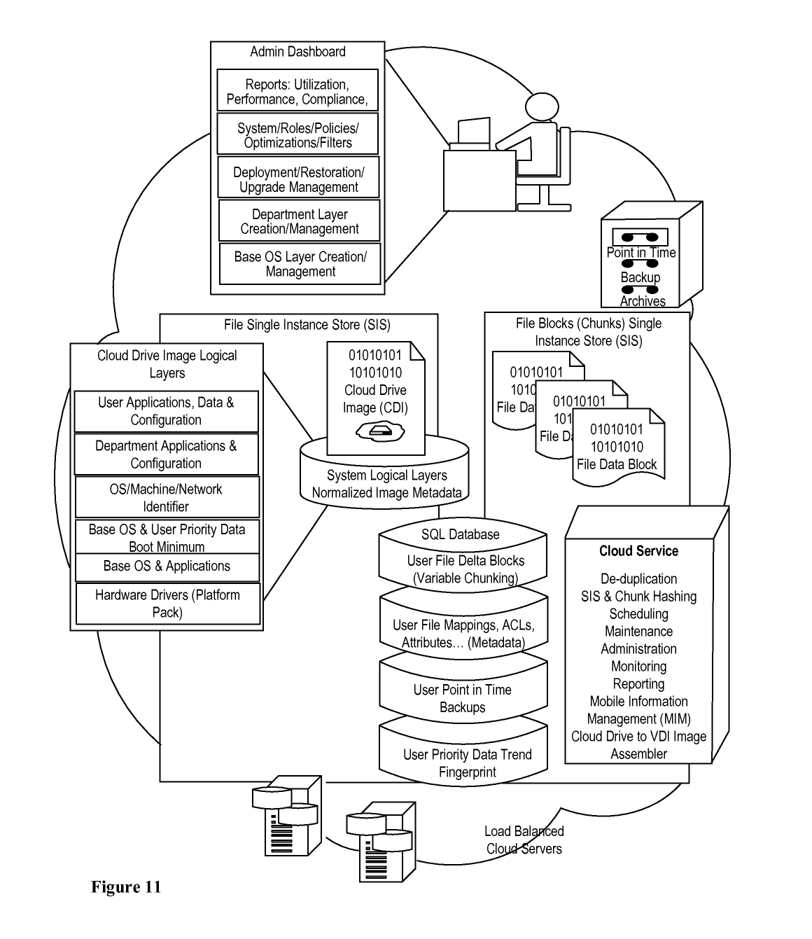

FIG. 12 depicts an exemplary embodiment of computing environment delivery service with offline operations;

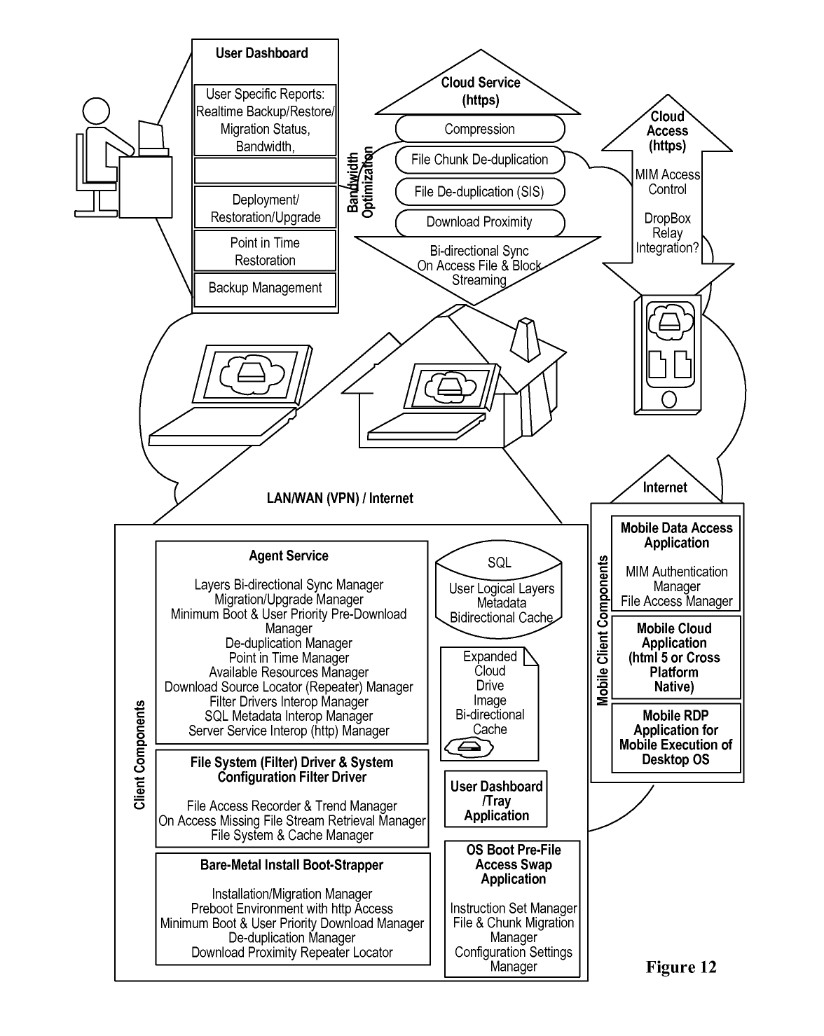

FIG. 13 depicts an exemplary embodiment of computing environment delivery service with offline operations;

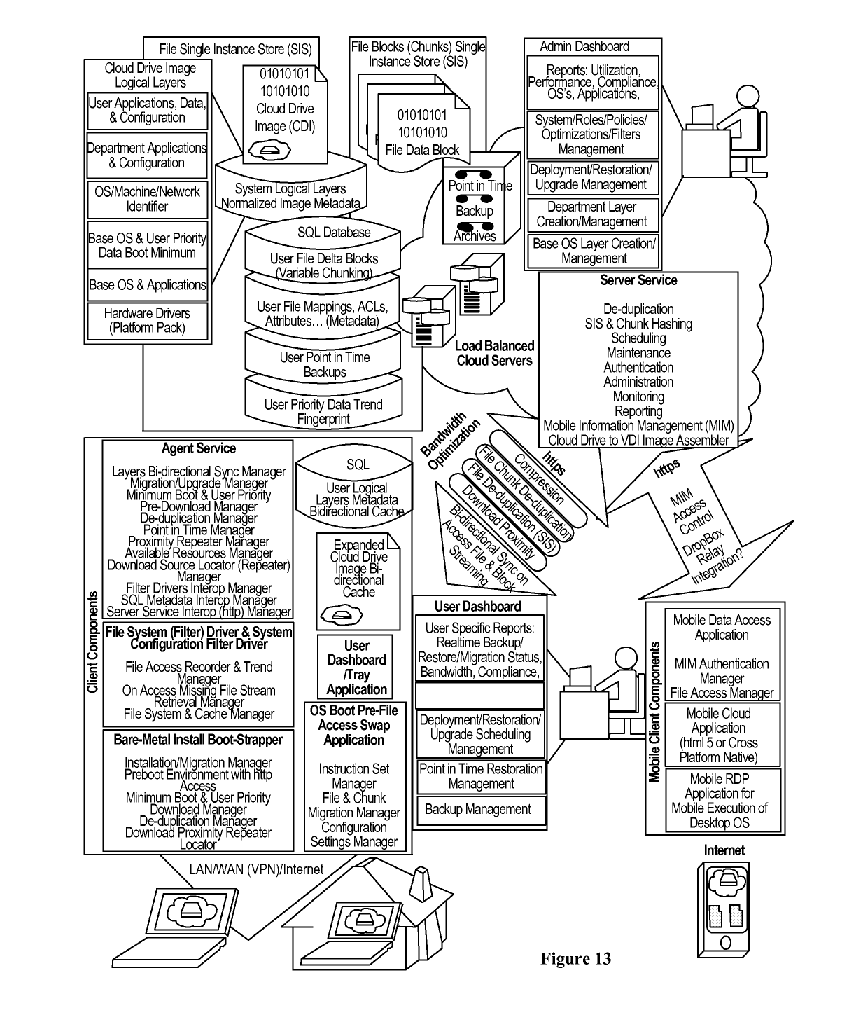

FIG. 14 depicts an exemplary embodiment of computing environment delivery service with offline operations;

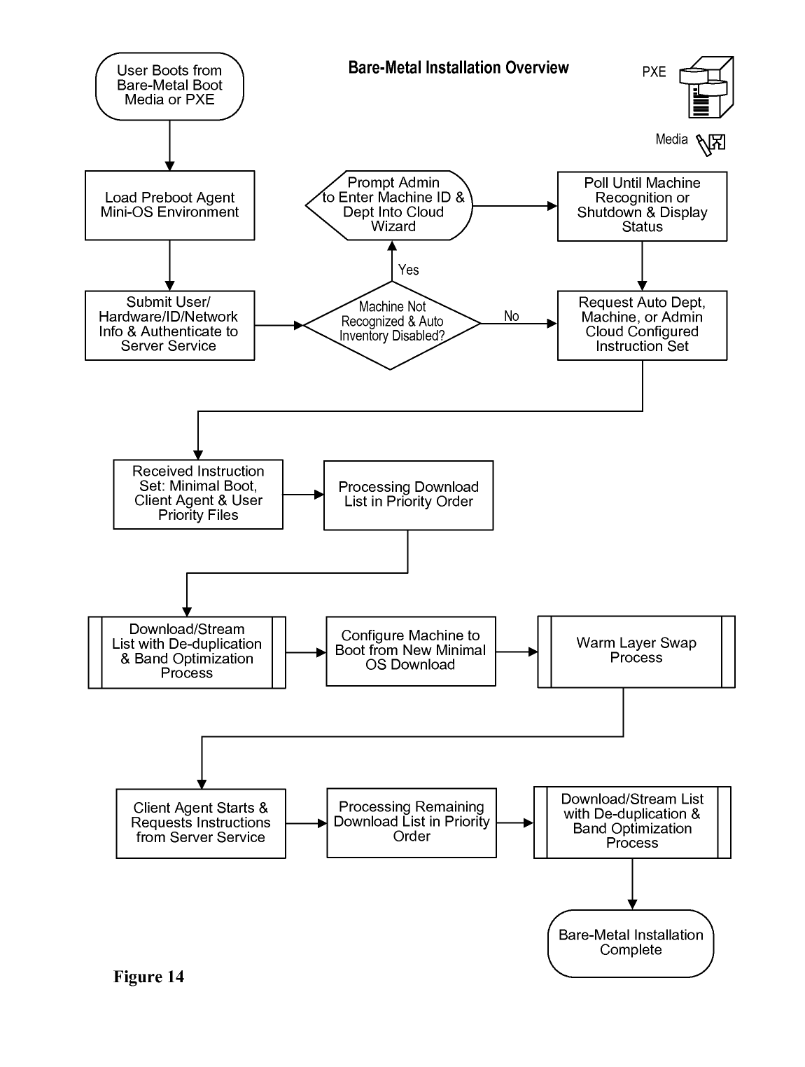

FIG. 15 depicts an exemplary embodiment of computing environment delivery service with offline operations;

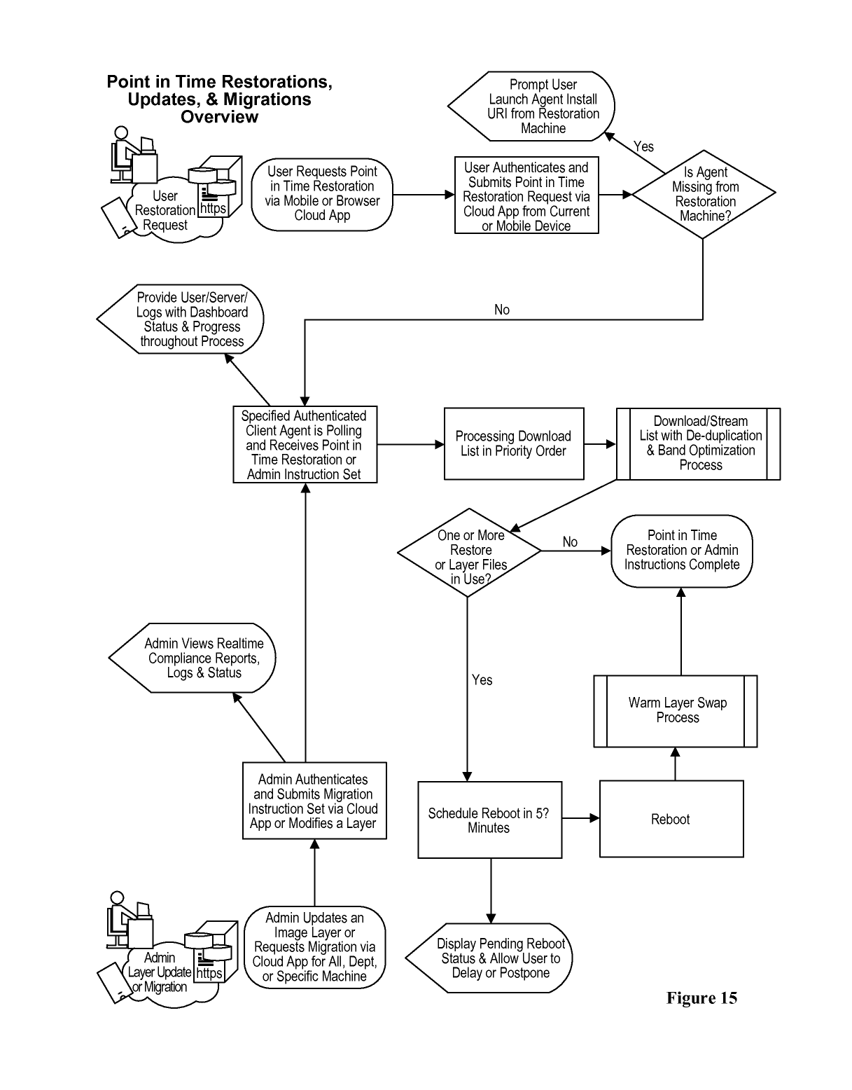

FIG. 16 depicts an exemplary embodiment of computing environment delivery service with offline operations; and

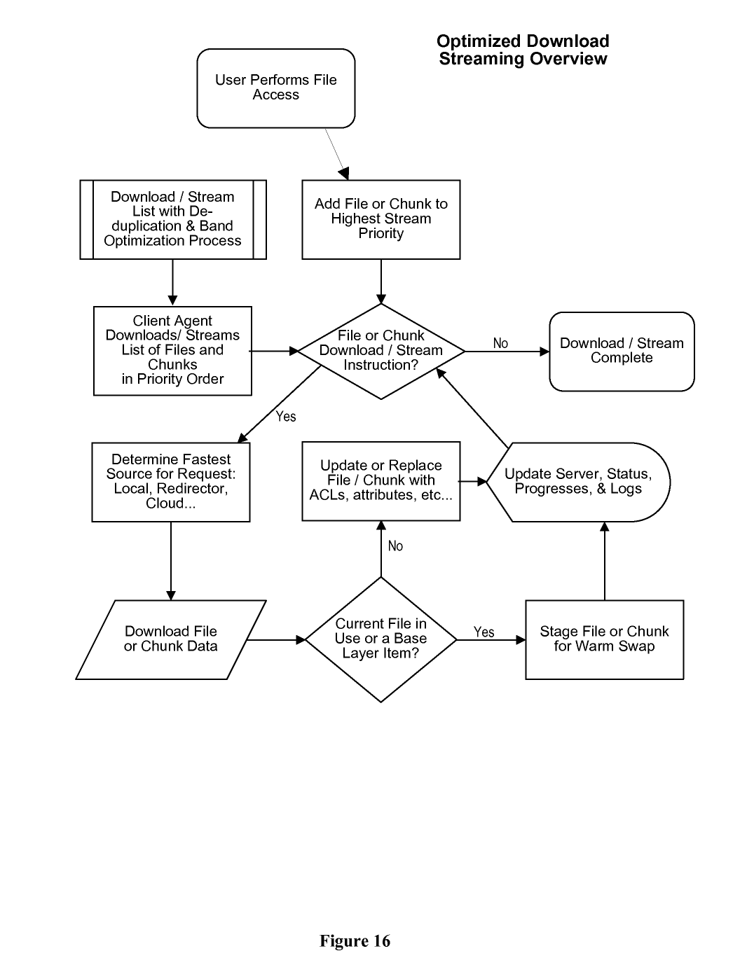

FIG. 17 depicts an exemplary embodiment of computing environment delivery service with offline operations.

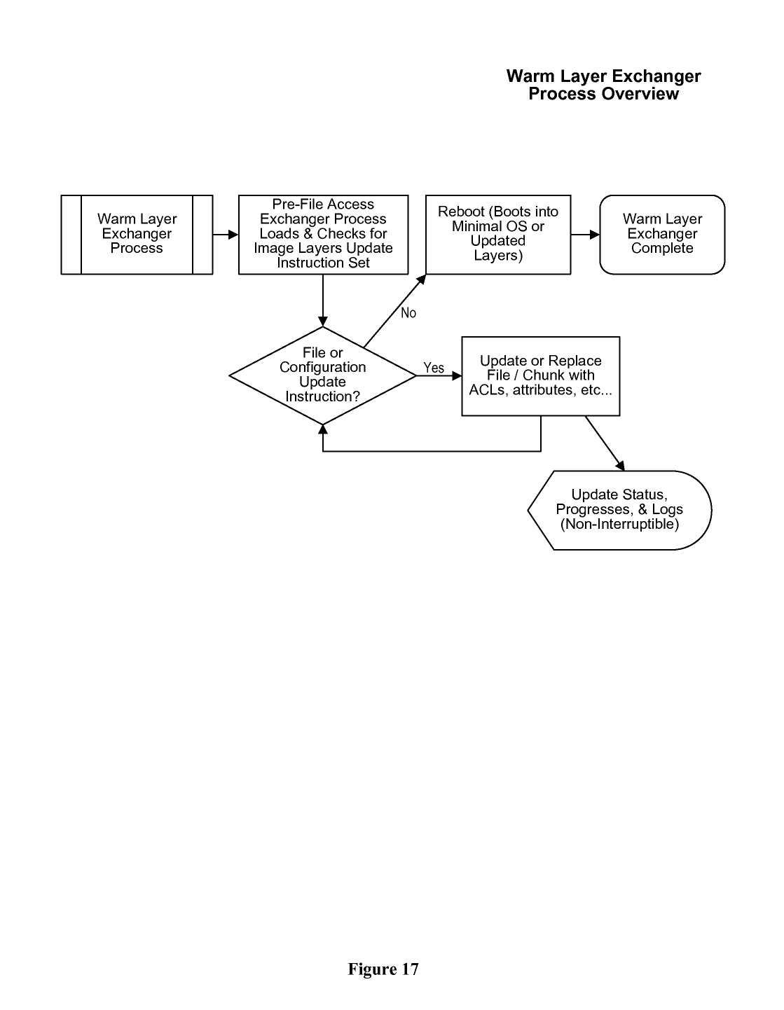

### DETAILED DESCRIPTION OF THE EMBODIMENTS

I. Storage and Distribution of Software

The description below describes servers, computers, and network elements that may include one or more modules, some of which are explicitly shown in the figures, others are not. As used herein, the term “module” may be understood to refer to software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. For modules that are software, a processor or other device may execute the software to perform the functions of the software. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, computers, network elements, etc.) separately. The functions described as being performed at various components may be performed at other components, and the various components may be combined and/or separated. Other modifications also may be provided.

As discussed above, virtual machine technology provides many benefits for businesses. However, because a virtual machine encapsulates an entire computer, use of virtual machines poses significant challenges due to its requirement for large amounts of data storage. The large storage requirements for virtual machines also make transporting virtual machines difficult. It should be noted that the challenge of maintaining computer system images only increases with company scale, particularly with organizations that maintain several computer system images and use a broad number of personal computer and server hardware models. Thus, a comprehensive and efficient system and method for capturing, storing, and distributing computer files may be provided.

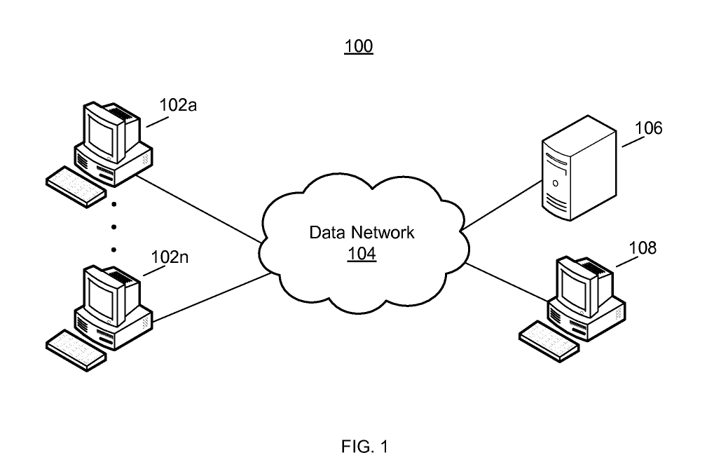

FIG. 1 illustrates a system for storing and distributing computer files 100, in accordance with various exemplary embodiments. The system 100 may provide for efficient capture, storage, distribution, management, and deployment of computer system images and hardware files to one or more target computers. The system 100 in accordance with exemplary embodiments may deploy a base system image to one or more target computers to quickly and efficiently replicate the base system image on a group of one or more target computers. In addition to deploying the base system image, the system 100 may identify and tailor distribution of hardware files from an archive based on hardware devices included in a given target computer, instead of deploying a single, one-size-fits-all computer system image that includes all hardware files that may be used by some, but not all, of the target computers in the group.

In an exemplary embodiment, the system 100 may include target computers 102a-102n, a data network 104, a server 106, and a base computer 108. The target computers 102a-102n, the server 106, and the base computer 108 may communicate with one another via the data network 104.

The components of system 100 may include a processor, a hard disk, a memory, a registry database, and one or more modules. The processor may be a central processing unit, a processing module, or other device capable of executing computer code. The hard disk may be a data storage device. The memory may store data loaded from the hard disk. The memory may be, for example, a random access memory (RAM) or other device for storing data. The components of system 100 also may be communicatively coupled to one or more hardware devices, such as, but not limited to, a biometric device, a computer monitor, a video controller, a sound device, a mouse, a network interface card, a peripheral device, a touchscreen, a biometric reader (e.g., a fingerprint reader), or other hardware devices coupled to and communicating with the components of system 100.

The computer 102 may be a variety of electronic devices. These may include desktop computers, laptops/notebooks, servers or server-like systems, modules, personal digital assistants (PDAs), smart phones, cellular phones, mobile phones, satellite phones, MP3 players, video players, personal media players, personal video recorders (PVR), watches, gaming consoles/devices, navigation devices, televisions, printers, and/or other devices capable of receiving and/or transmitting signals and/or displaying electronic content. It should be appreciated that the computers 102a-102n may be mobile, handheld, or stationary. It should also be appreciated that the computers 102a-102n may be used independently or may be used as an integrated component in another device and/or system.

The data network 104 may be a wired network, a wireless network, and/or combinations thereof. The data network 104 may transport digital and/or analog data signals using one or more transport protocols. The data network 104 may be any network, such as a local area network (LAN), a wide area network (WAN), a service provider network, the Internet, or other similar network. In some embodiments, the data network 104 may be a service provider network. It should be appreciated that the data network 104 may use electric, electromagnetic, and/or optical signals that carry digital data streams.

It should be appreciated that system 100 illustrates a simplified system, and that other devices and software not depicted may be included in the system 100. It should also be appreciated that the system 100 illustrates a single data network 104, a single server 106, and a single base computer 108. It should be appreciated that multiple instances of these devices may be also be provided.

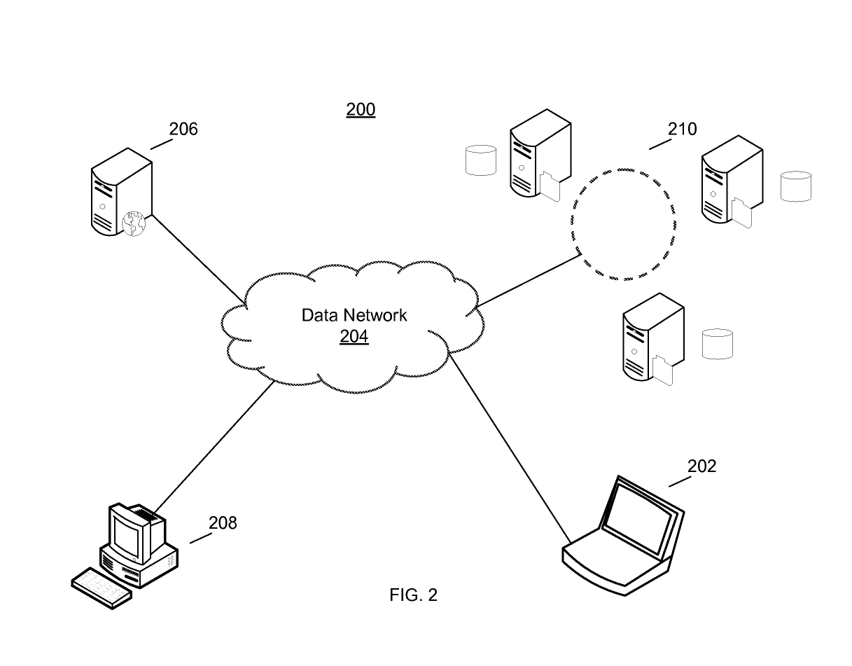

FIG. 2 illustrates a system for storing and distributing computer files 200, in accordance with an exemplary embodiment. The system 200 may provide for efficient capture, storage, distribution, management, and deployment of computer system images and hardware files to one or more target computers. The system 200 in accordance with exemplary embodiments may deploy a base system image to one or more target computers to quickly and efficiently replicate the base system image on a group of one or more target computers. In addition to deploying the base system image, the system 200 may identify and tailor distribution of hardware files from an archive based on hardware devices included in a given target computer, instead of deploying a single, one-size-fits-all computer system image that includes all hardware files that may be used by some, but not all, of the target computers in the group.

In an exemplary embodiment, the system 200 may include components similar to those shown in system 100 of FIG. 1. For example system 200 may include a target computer 202, a data network 204, a server 206, and a base computer 208. The server 206 may be a server that provides web services. The server 206 may provide logic and/or processing capability to configure and set up the data network 104 for communication and image capture and deploy. The base computer 208 may be a virtual machine builder. The system 200 may also include a one or more servers 210 that function as a resource library. The one or more servers 210 may be a collection of servers hosting a library resource for files, accessible through the data network 204. The components of system 200 may communicate with one another via the data network 104.

The computer 202 may be a virtual machine end user. In some embodiments, the end user may be provided a selectable catalog from which to install one or more virtual machines. In other embodiments, the end user may not be a fixed client. Rather, the end user may use a web-based application on the computer 202 to transfer payload. Other various embodiments may also be provided.

It should be appreciated that the components of the systems 100 and 200 may be servers, network storage devices or other devices communicatively coupled to the communication network 160. In one or more embodiments, components of the systems 100 and 200 may perform any, or a combination, of storing, receiving, transmitting, producing, aggregating, and/or uploading electronic content. The components of the systems 100 and 200 may also perform other functionality including, but not limited to, any, or a combination, of storing, indexing, consolidating, distribution, management, etc.

In some embodiments, the components of the systems 100 and 200 may contain or be communicatively coupled to storage, such as a redundant array of inexpensive disks (RAID), a storage area network (SAN), an internet small computer systems interface (iSCSI) SAN, a Fibre Channel SAN, a common Internet File System (CIFS), network attached storage (NAS), a network file system (NFS), tape drive based storage, or other computer accessible storage.

Additionally, components of the systems 100 and 200 may communicate with any, or a combination, of other systems, applications, and storage locations directly via one or more of an Application Programming Interface (API), a Remote Procedure Call (RPC), an interface table, a web service, an Extensible Markup Language (XML) based interface, a Simple Object Access Protocol (SOAP) based interface, a Common Request Broker Architecture (CORBA) based interface, and other interfaces for sending or receiving information.

Data may be transmitted and received utilizing a standard telecommunications protocol or a standard networking protocol. For example, one embodiment may utilize Session Initiation Protocol (“SIP”). In other embodiments, the data may be transmitted or received utilizing other Voice Over IP (“VoIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, Internet Control Message Protocol (“ICMP”), User Datagram Protocol (“UDP”), or other protocols and systems suitable for transmitting and receiving data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols including IEEE 802.11a, 802.11b and 802.11g. Network 102 may also use protocols for a wired connection, such as an IEEE Ethernet 802.3.

Components of the systems 100 and 200 may each be responsible for different functionality in an electronic content distribution network. By way of non-limiting example, the components of the systems 100 and 200 may produce, receive, organize, aggregate, and deploy electronic content, such as system images. Processing of electronic content may include any, or a combination, of indexing, categorizing, storing, formatting, managing, translating, filtering, imaging, deploying, compressing, encrypting, securing, replicating, and further processing. System images and/or files may be produced by user or third-party input. By way of non-limiting example, content may be grouped or stored in databases or other storage, which may be separated according to various embodiments.

Referring to system 100, a system administrator or other user may desire to replicate common computer software applications, device drivers, files, data, etc., and/or other information to one or more of a group of target computers 102. The system administrator may install the desired computer software applications, device drivers, files, data, etc., and/or other information on the base computer 108. The system administrator may instruct the base computer 108 to create a base system image of the computer software applications, device drivers, files, data, etc., and/or other information to be commonly deployed to the target computers 102. The base system image may be a copy of the computer software applications, device drivers, files, data, etc., and/or other information installed on the base computer 108. The base system image may be a least common denominator of software and data that the system administrator desires to distribute to a group of target computers 102. For example, the system administrator may create a base system image containing an operating system and productivity and line-of-business applications to be used by each target computer 102 of the group of target computers 102a-102n.

In addition to creating the base system image, the system administrator may use the base computer 108 to create an image module. In an exemplary embodiment, the image module may be a standalone, portable archive that may provide logical and physical separation of software content (i.e., the base system image) from hardware platform support (i.e., hardware files). The portable archive, which may be compressed, may comprise one or more hardware files, and may also contain smart virtual machine executable code. For example, the image module may be a ZIP file (or other compressed file or file format) where the smart virtual machine executable code uses a commercially available application program interface (API) to extract the relevant hardware files to the target computers 102. Determining which hardware files to extract will be discussed in further detail below.

The separation of software content and hardware platform support may dramatically simplify the impact evaluation process when updating hardware or software of the target computers 102. For example, if a new hardware device (e.g., a new computer model, a new peripheral device, etc.) is introduced to one or more of the target computers 102, the IT staff may update the image module with hardware files to support the new hardware device without modifying the base system image. Separating hardware files from the base system image may decouple the base system image from hardware changes. Updates may be made to the image module, instead of to the base system image. This results in efficiencies as replicating the image module across the data network 104 is more efficient than adding new hardware files to the base system image because the hardware files may be much smaller than the base system image. Typically, a size of all of the hardware files included in the image module may be at least an order of magnitude smaller than the base system image. In another example, if the IT staff desires to add a new software application (e.g., productivity application) to one or more of the target computers 102, the IT staff may update the base system image to add the new software application without an update of the image module 250.

Alternatively, if a user who prepared a presentation on his or her computer or device, having its own set of specific hardware and software specifications, wanted to provide a demonstration of his or her presentation in another computer or device, having a different set of hardware and software specifications, the user may be able to do so seamlessly using the base image (which may be comprises of one or more sub-images) of his or her system. Separating hardware files from the base system image (or images) may decouple the base system image from hardware changes. Updates may be made to the image module, instead of to the base system image. This results in efficiencies as replicating the image module across the data network 104 is more efficient than adding new hardware files to the base system image because the hardware files may be much smaller than the base system image. Furthermore, the image module may be able to search and receive files necessary for seamless demonstration of the presentation or other application. This may be achieved with entirely or partially over the data network 104.

The following describes deploying a base system image to a target computer 102, where the target computer 102 locally accesses and executes the base system image and an image module communicatively coupled to the target computer 102. In an exemplary embodiment, the system administrator may locally deploy the base system image while working on a target computer 102 by reading the base system image from a recordable media (e.g., DVD, CD, Flash Drive, Universal Serial Bus (USB) Drive, etc.) and storing the base system image on a hard drive of the target computer. After the base system image has been deployed, the target computer 102 may access the image module by reading a recordable media and may execute the image module.

It is noted that the image module also may be accessed and executed at the server 106 via the data network 104 or at other locations local or remote to the target computer 102 and that the image module may interact with the target computer 102 via the data network 104. For example, the system administrator may deploy a base system image to one or more of the target computers 102a-102n from the server 106 via the data network 104 and the image module may interact with the target computer 102 via the data network 104. In another example, or the system administrator may deploy the base system image to the target computers 102 from the base computer 108 or other remote computers (not shown) via the data network 104 and the image module may interact with the target computer 102 via the data network 104. Other modifications also may be made.

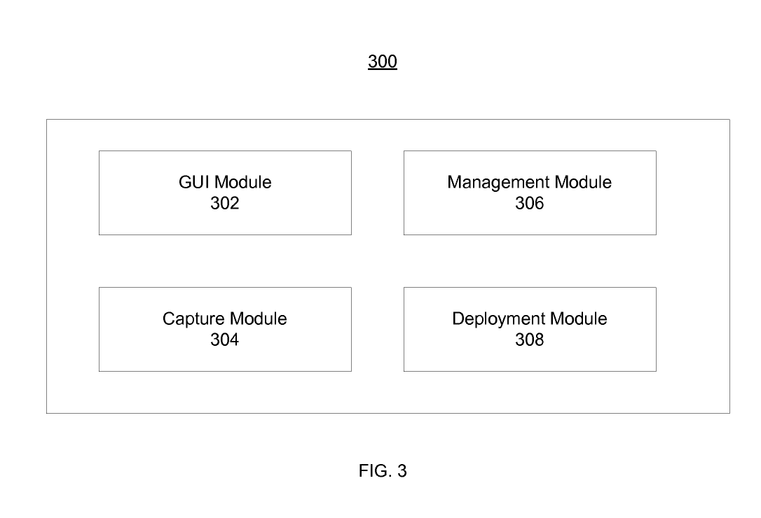

The components of system 100 may communicate with and/or execute the image module 300 of FIG. 3 to determine which hardware files to deploy to support the hardware devices.

FIG. 3 illustrates an image module for storing and distributing computer files 300, in accordance with exemplary embodiments. The image module 300 may include a graphical user interface (GUI) module 302, a capture module 304, a management module 306, and a deployment module 308. It is noted that modules 300, 302, 304, 306, and 308 are exemplary and the functions performed by one or more of the modules may be combined with that performed by other modules. The functions described herein as being performed by the modules 300, 302, 304, 306, and 308 also may be separated and may be performed by other modules remote or local to the computer 102 or 202.

The graphical user interface (GUI) module 302 may present various graphical user interfaces to the user at the computer 102 and/or 202. The graphical user interface provided by the GUI module 302 may allow a user to select one or more computer systems and/or collections of software for image creation. The computer systems may represent physical machines or virtual machines.

The capture module 304 may capture a virtual machine or software for a physical machine such as an operating system and/or a collection of software. The capture module 304 may be communicatively coupled with several other modules depicted in FIG. 3. For example, when capturing a virtual machine, the capture module 304 may operate alongside the other modules to ensure that the captured image is single-instanced and does not include duplicate files. Methods and systems for ensuring that a captured image is single-instanced are described in the U.S. patent application Ser. No. 12/023,534, filed Jan. 31, 2008, entitled “Method and System for Modularizing Windows Imaging Format,” which is hereby incorporated by reference in its entirety. Alternatively, the capture module 204 may also communicate with the other modules to determine whether the captured image may fit onto the media that will be used to distribute the image. For example, if the image is to be distributed via a network, the file size may be limited by the transmission capacity of the network. In other embodiments, if the parent image is greater in size than the storage capacity of a CD or DVD disk or other media, such as USB, flash, SD, or other similar storage media, then the image may be spanned over several disks/media.

The management module 306 may determine file size limitations based on the way (e.g., over a network, via physical media, etc.) with which the images are to be distributed. The management module 306 may be communicatively coupled with the other modules. The management module 306 may be used in a determination as to whether an image should be spanned across different media or distribution channels. In some embodiments, the management module 206 may also be communicatively coupled with a GUI module 302. In this scenario, the transmission/storage capacity of the network/media with which the image is to be distributed may be input by a user using the GUI module 302.

The creation of the image may take into account the capacity of the method of transmission with which the image is to be distributed. This information may be received from the management module 306 working in conjunction with the GUI module 302 and may determine which method with to distribute the images, e.g., via several transmissions over a network or over several physical media. The management module 306 may also be communicatively coupled with the capture module 304 and may refer to a system, a collection of software, or a combination of a collection of software and a system that is to be captured.

The management module 306 may create a consolidated image that is single-instanced and does not include duplicate files. The consolidation module may prevent the duplication of files and may therefore conserve memory space in both the physical and virtual machine context. Some of the functions of the management module 306 are described in the U.S. patent application Ser. No. 11/836,552, filed Aug. 8, 2007, entitled “Methods and Systems for Deploying Hardware Files to a Computer,” which is herein incorporated by reference in its entirety.

The deployment module 308 may distribute one or more images to the computer 102.

The methods and systems disclosed in the present application describe modularizing the image and storing the various components of the image on a central server. With this configuration, images (i.e., a software replica of a computer) may be created with reference to known images; thus decreasing the amount of data in each image. The process of creating software images from the computer's contents may be described as the “capture” process. Once captured, the software images may be deployed (i.e. run on a different machine) more efficiently and easily than using conventional media containing a large monolithic system image file. Using the systems and methods for capturing and organizing software images described herein, deployment may be accomplished with a much smaller file that may be emailed, downloaded, or linked to. Exemplary embodiments are described below.

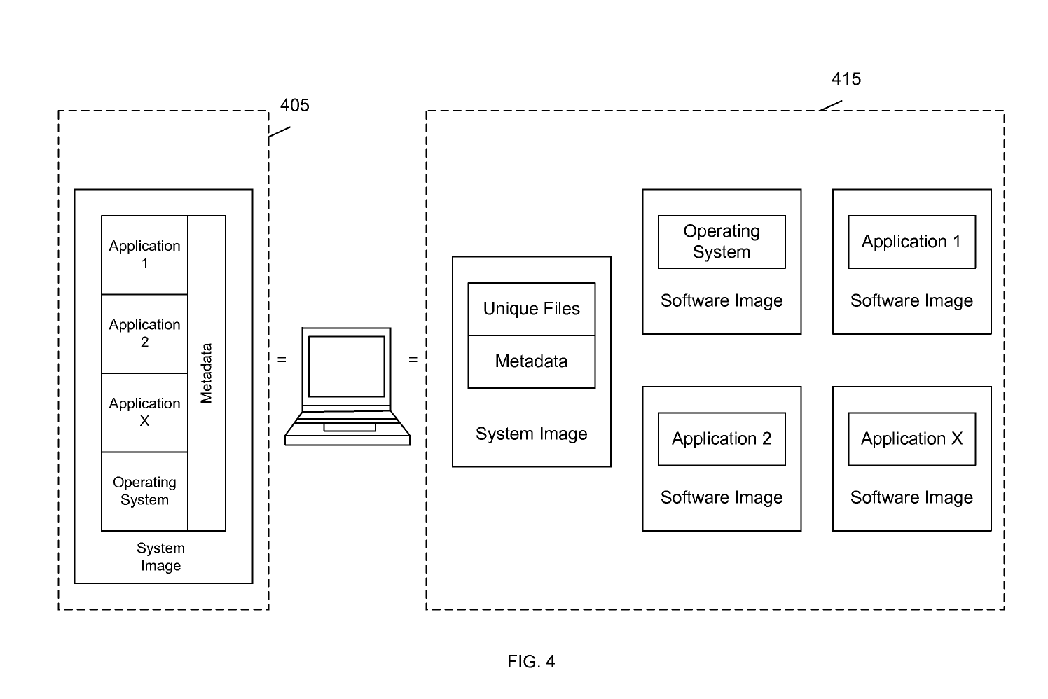

FIG. 4 illustrates a modular system imaging format, in accordance with an exemplary embodiment. In a conventional system, a computer system image 405 may be captured in a one-size-fits-all fashion. However, the same computer system image 405, according to some embodiments, may be separated into one or more software images 415. Software images may contain only the files of a specific software program. For example, if a computer system image contains an operating system and three applications, it may be separated into four individual software images.

In an exemplary embodiment, the capture module 304 may identify what is unique to a given system when a remote computer is being captured. Further, the module may then replicates that process with reference to software images stored on a network server when recreating the system on the deploy side. The module may identify, isolate, and/or store files specific to a given software program, including but not limited to, operating systems, applications, software suites.

Embodiments of the present disclosure may be considered analogous to single-instance storage, except that it may be applied for software programs. In other words, single-instance storage in the creation of a system image may be a process that creates a system image without creating duplicate files. Here, only the unique files may be stored as the image. These unique files, which are much smaller in size than the original image, may then be used to recreate the original image.

In an exemplary embodiment systems and methods perform the process of optimizing software images by identifying and removing system-unique files including but not limited to, registry hive files, system state files, log files. Exemplary systems and methods may perform the process of optimizing software images by identifying and removing system-unique metadata, including but not limited to, file security (access control lists), file attributes, file names, file path information.

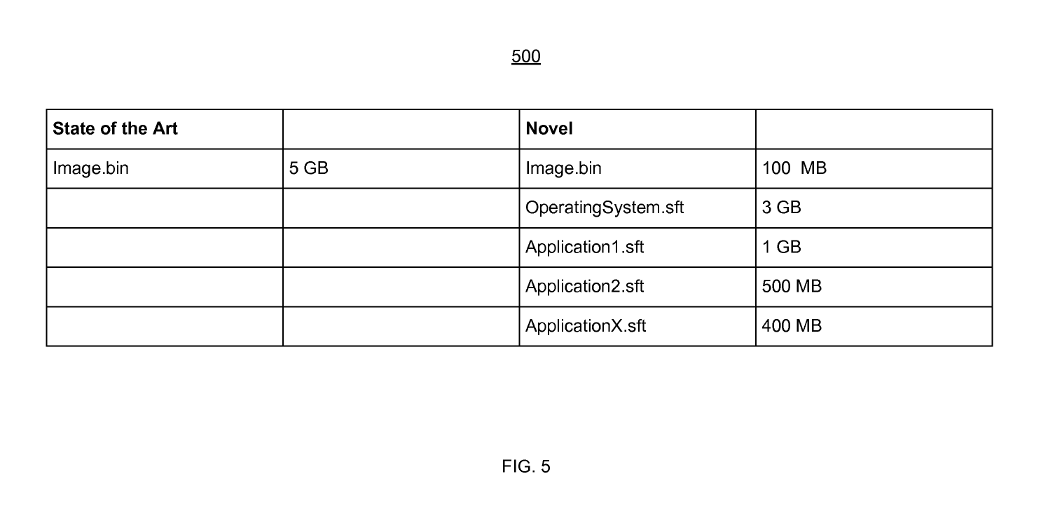

FIG. 5 illustrates a file representation format 500 for the modular system imaging format of FIG. 4, in accordance with an exemplary embodiment. A proprietary image format may contain only a subset of the information contained within a software image. This format may be used in place of the larger software image format for purposes such as identifying what files to include or exclude from an image creation process. This image format may contain data including but not limited to; file hash table, file lookup table, etc.

In an exemplary embodiment, systems and methods implement the concept of using a proprietary image format may contain only a subset of the information found in traditional images. Specifically, an image format that is missing the actual file backing data, but contains file hash information may be used in identifying what files to include or exclude during image creation. This may allow for the creation of new system or software images without the presence of large software images. For example, a 5 GB software image may be represented by as little as 5 MB by selective capture (e.g., to backup one those resources that are needed or required). Other ways to reduce image size may also be provided, such as compression, and the like.

The various embodiments described above provide advantageous solutions to various problems known to exist with conventional images. For example, in a business or other setting it might be necessary for a laptop to be imaged so that the exact contents of the laptop could be reproduced and deployed on another computer at another location. Conventional systems would create a system image that was an exact picture of the laptop, but the image might be large and not organized in a manner different from the organization of captured laptop. The large system image would then be physically sent on a disk, or possibly hosted on a website where it could then be downloaded, and restored using the same utility that captured the large image. This type of conventional capture-and-deploy scenario uses a tool that creates a system image and the same tool is then used to deploy the system image on a remote computer.

In embodiments of the present disclosure, the capture imaging process involves systems and methods where the computer's relevant files are selectively captured and organized in unique configurations as software images that are different from the configuration employed by the computer. Once captured, the software images may be stored in conventional formats or a repository of software images is maintained on a web server. The software images may then be deployed using proprietary systems and methods that recognize the selected and organized software images captured from the laptop and deploy the software images onto another remote computer such that the remote computer represents a copy of the original laptop. This allows the laptop to be imaged in ways described in various embodiments in order to determine, for example, what aspects of the laptop are already stored in the library of programs, and what aspects are unique to that laptop. Using the systems and methods described herein one may generate a representation of the laptop using software images that is much smaller than a system image of the laptop captured in the conventional manner.

The systems and methods described herein selectively create software images and organize (and reorganize) those software images in new advantageous ways. For example, virtual machines may be used by companies that want to distribute their virtual machines to many different employees located throughout the world.

To deploy a virtual machine to different employees located throughout the world, a company could utilize the systems and methods described herein to generate and then distribute smaller, web-based installation packages containing a deployment engine and system image that reference the software image library. For example, if a virtual machine contained Windows and Office, that virtual machine could be run through a special process which compared the virtual machine to the software image library—which may be accessible worldwide via the internet. This process may generate a small system image that would only have the unique files that were part of a particular demo that the virtual machine was created to run. This small file could be linked back to the customer who could provide the link to all of their employees that need to install this demo on their machine.

The employees may then click on the link and it will download that small version of the file. In embodiments of the present disclosure, the file includes instructions on how to put the virtual machine back together by referring to the software image that has already been replicated and is stored on an accessible network.

It should be appreciated that the unique configuration provided may not be limited to software applications, as depicted in FIG. 4. Other various embodiments for unique configurations may also be provided.

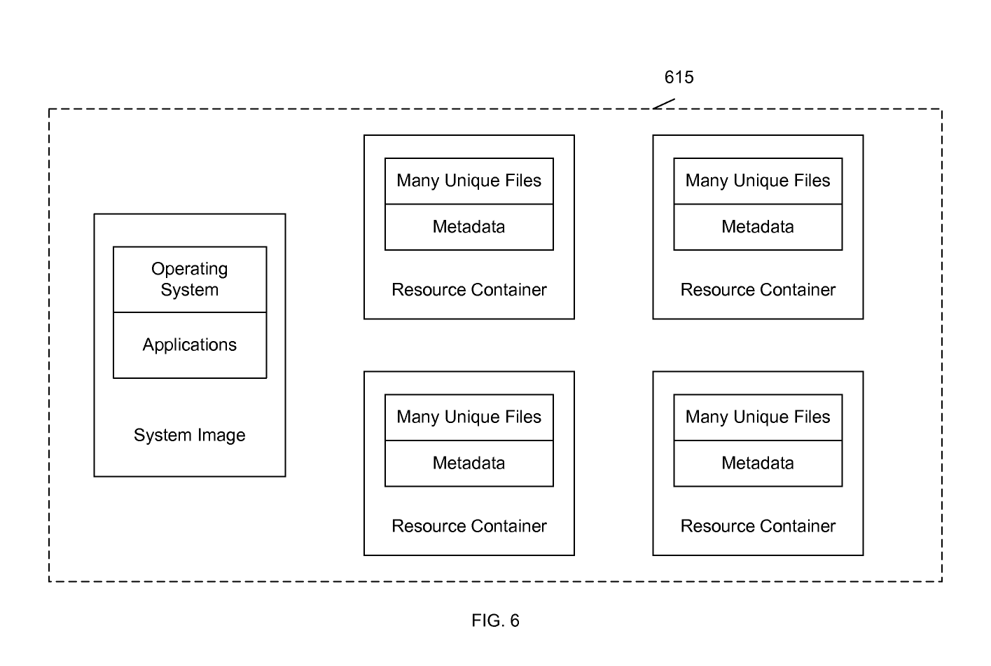

FIG. 6 illustrates a modular system imaging format 600, in accordance with an example embodiment. Rather than capturing at the software or application level, the system image may be provided in a more granular configuration. As shown in the system imaging format 600, the system image may be organized in groups of unique files and metadata within “resource containers.” These resource containers may be comprised of more than one computer file, but less than a full software application, or a combination of large resource containers or elemental file images. A variety of configurations may be also be provided.

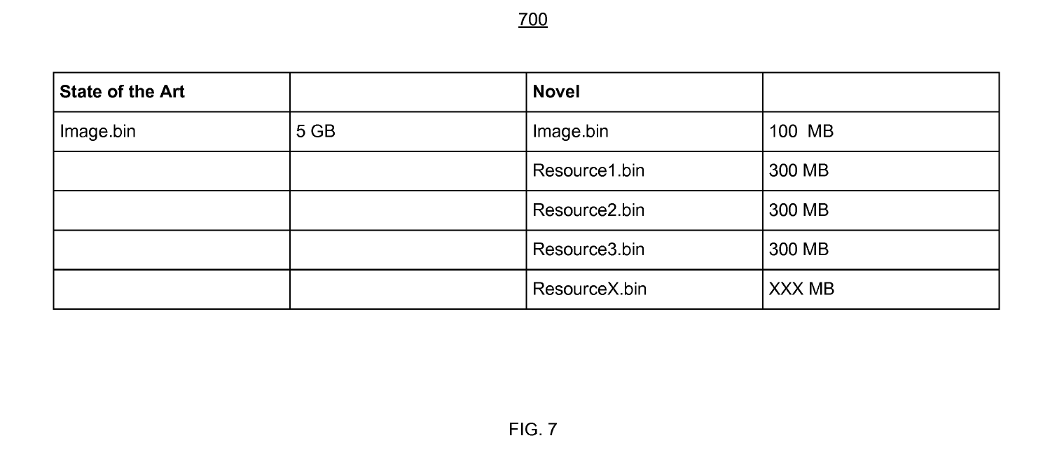

FIG. 7 illustrates a file representation format 700 for the modular system imaging format of FIG. 6, in accordance with an exemplary embodiment. A proprietary image format containing only a subset of the information contained within a software image may be provided. This format may be used in place of the larger software image format for purposes such as identifying what files to include or exclude from an image creation process. This image format may contain data including but not limited to; file hash table, file lookup table, and the like.

In an exemplary embodiment, systems and methods implement the concept of using a proprietary image format that contains only a subset of the information found in traditional images. Specifically, an image format that is missing the actual file backing data, but contains file hash information to be used in identifying what files to include or exclude during image creation. This allows the creation of new system or software images without the presence of large software images. For example, a 5 GB software image may be represented by a variety of “resource containers,” which may represent a group of files or a single file. The group of files may be a software suite, a software application, and/or a cluster of files that work together within a software application. These resource containers may be of various sizes and offers flexibility in providing unique configuration of images for capture, storage, organization, and/or deployment.

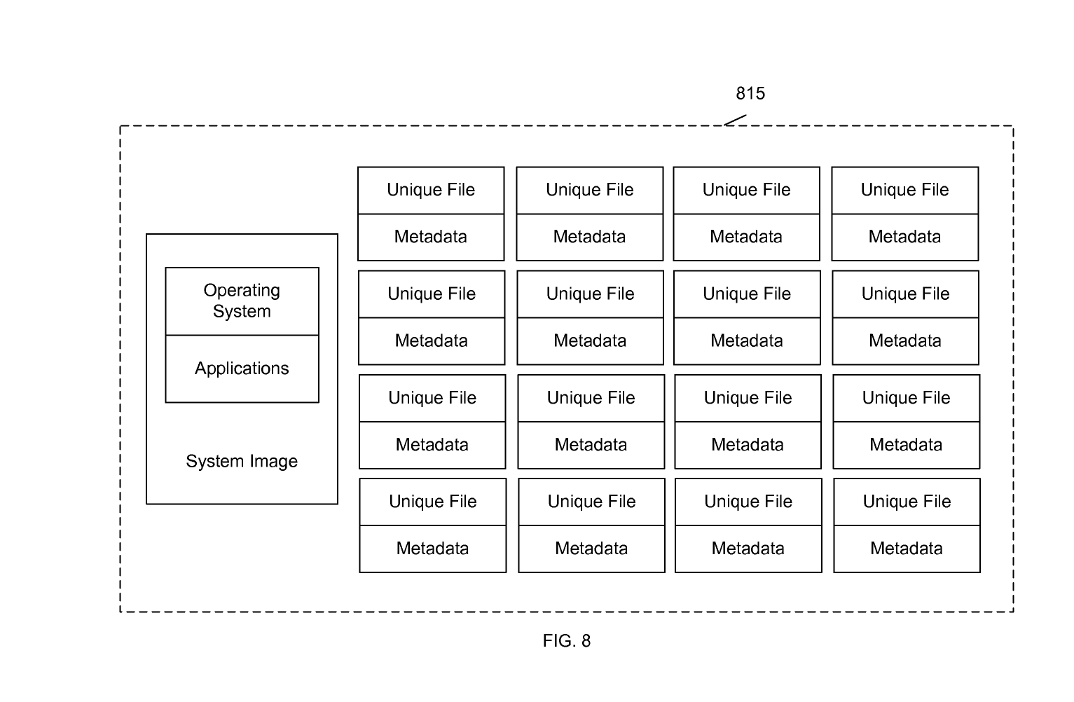

FIG. 8 illustrates a modular system imaging format 800, in accordance with an example embodiment. In this example, unlike the format of 400 and 600, the system image format 800 may provide an even more granular configuration. As shown in the system imaging format 800, the system image may be completely broken down into individual files and corresponding metadata.

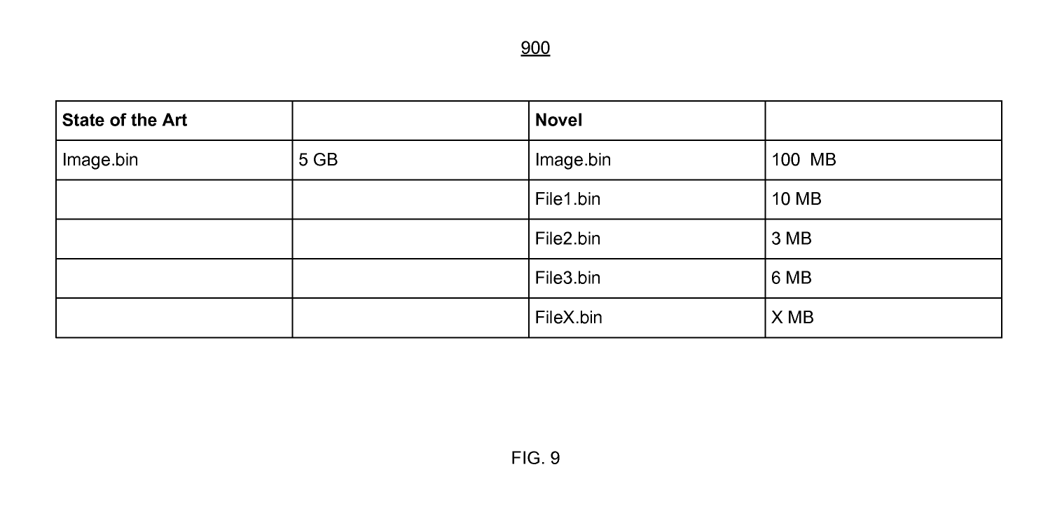

FIG. 9 illustrates a file representation format 900 for the modular system imaging format of FIG. 8, in accordance with an example embodiment. A proprietary image format containing only a subset of the information contained within a software image may be provided. This format may be used in place of the larger software image format for purposes such as identifying what files to include or exclude from an image creation process. This image format may contain data including but not limited to; file hash table, file lookup table, and the like

In an example embodiment, systems and methods may implement the concept of using a proprietary image format that contains only a subset of the information found in traditional images. Specifically, an image format that is missing the actual file backing data may be recreated using software images of individual files. Capture, storage, organization, and deployment of these fundamental file images may be relatively simple and without the presence of large software images, which may be cumbersome if only a few file images are needed. As discussed above, individual file images may be used in conjunction with any of the embodiments described above to provide a robust yet efficient way to backup resources for deployment.

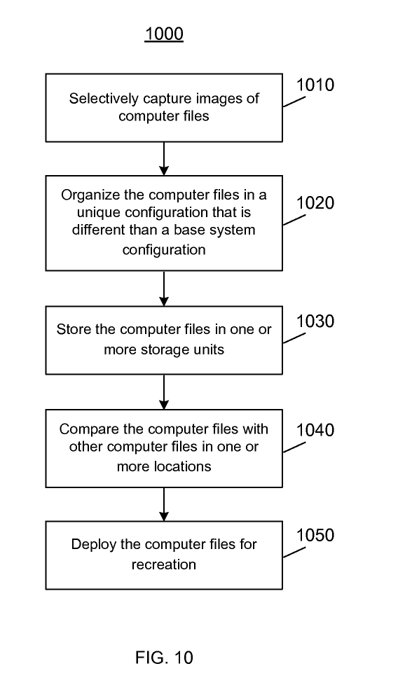

FIG. 10 illustrates an illustrative flow of a method for storing and distributing computer files, in accordance with an example embodiment. The method 1000 is provided by way of example, as there are a variety of ways to carry out methods disclosed herein. The method 1000 shown in FIG. 10 may be executed or otherwise performed by one or a combination of various systems. The method 1000 is described below as carried out by at least system 100 in FIG. 1, system 200 in FIG. 2, and/or module 300 in FIG. 3, by way of example, and various elements of systems 100 and 200 and/or module 300 are referenced in explaining the example method of FIG. 10. Each block shown in FIG. 10 represents one or more processes, methods, or subroutines carried in the exemplary method 1000. Computer readable media comprising code to perform the acts of the method 1000 may also be provided. Referring to FIG. 10, the exemplary method 1000 may begin at block 1010.

At block 1010, the capture module 304 may be configured to selectively capture images of computer files. In some embodiments, the capture module 304 may selectively capture images of computer files by building out a virtual machine containing the computer files to be captured. The computer files for capture may be mounted to at least one storage medium. The computer files may be copied and converted into an imaging file format. In some embodiments, conversion may be achieved using conversion tools, such as SmartWIM, Microsoft ImageX, and/or other imaging/conversion tools.

At block 1020, the management module 306 may be configured to organize the images of computer files in a unique configuration that is different than a configuration employed by a base system image. In some embodiments, the images of computer files may be organized by at least one of type, size, name, application, extension, designation, metadata, and/or program association.

It should be appreciated that in some embodiments, the unique configuration may be application-based, such that the images of computer files are organized in groups based on an application, a program, an operating system, and/or an application suite. The unique configuration may be file-based, such that the images of computer files are organized as individual file images. The unique configuration also may be based on a plurality of groupings comprising application-based groupings, file-based groupings, customized groupings, and/or a combination thereof. Using a unique configuration as described above, as opposed to a single base system image, may provide efficient capture, storage, and deployment and optimizes performance.

At block 1030, the management module 306 may be configured to store the image of computer files in one or more storage units communicatively coupled to the module (e.g., image module 300).

At block 1040, the management module 306 also may be configured to determine whether the computer files exist at one or more data storage units. The determination may be achieved by analyzing the one or more data storage units for the computer files.

At block 1050, the deployment module 308 may be configured to deploy the images of computer files to a computer for recreation of the base system image. In some embodiments, the images of the computer files may be selectively deployed. In effect, the base system image may recreated using the images of the computer files when the computer files are targeted for use at the computer, selected by a user at the computer, required to run an associated application at the computer, and/or a combination thereof.

Deployment may include a gradual building of the new virtual machine in sort of a “piece meal” fashion as opposed to deploying everything at once, e.g., in one single base system image. For example, the storage for resources may, in effect, become “smarter” since it may be built as a user decides what he or she wants to access and what he or she will need. Therefore, assuming the images may exist and are stored in the cloud (e.g., data network 104) or other location, the user may decide that he or she needs to do X, Y, or Z, and the images of computer files that are required to perform X, Y, or Z may then be pulled and/or deployed to the user's device.

It should be appreciated that there may be a one to one ratio between a source virtual machine and the deployed virtual machine. The deployed virtual machine may be exactly the same as the source virtual machine. There may be flexibility, however, in the middle of the process, which determines how the virtual machine is efficiently deployed from one to the other. Thus, the virtual machine does not necessarily grow or change and once deployed, the virtual machine may be entirely at the end user's disposal and he or she may do with it whatever they want. From a deployment side of things, back and forth communication may be reduced, if not fully terminated, once the virtual machine has been fully deployed. Accordingly, the resources (e.g., as they exist in the cloud) may be leveraged in an ongoing basis to provide a “smart cache” so that end users only download resources that they need for the content that they care about. Therefore, what end users receive is not one large image blob that contains resources for, say, fifteen (15) different virtual machines when they really only care about one. User machines may download only the resources or relative resources needed for all the content needed. Over time, the system may become “smarter” by using artificial intelligence technology and/or machine learning based on end user interaction. For example, as the end user continues to use the content, the system may “learn” what content this is and download only the resources for the content the end user appears to need (and thus not having to pull down all resources for content he or she us not currently interested in).

In another example, a user may desire to pull down Virtual Machine A where Virtual Machine A may contain an operating system and an application suite (e.g., Microsoft Office). After a predetermined amount of time, such as a day, a week, a month, and/or another predetermined amount of time, the user may decide that he or she needs Virtual Machine B. Virtual Machine B may include the operating system, the application suite, plus an additional application associated with the application suite (e.g., Visual Studio). A“smart cache” may know that the end user may have all the images/files for the operating system and the application suite (from Virtual Machine A). Accordingly, the operating system and application suite may not be pulled since it may already be in local storage. Therefore, the only item required for transfer in order to form Virtual Machine B may be transferring the files associated with the additional application. As a result, as more and more data gets downloaded, not only does the cache increase in size, but it may also become “smarter,” recreating the virtual machine in an efficient manner that optimized resources.

The system in accordance with example embodiments may detect what hardware files are used by particular target computers and may deploy the hardware files used by particular target computers. This advantageously does not burden the base system image with hardware files that are used by only a subset of the target computers. Moreover, the system in accordance with example embodiments advantageously uses the image module to separate the base system image from the hardware files. Updates to the hardware files may be made and an update image module may be distributed without involving redistributing the base system image to all target computers. Likewise, the base system image may be updated with involving redistribution of the image module. This separation results in savings in terms of time, bandwidth, and administrative complexity for any organization that approaches deployment of base system images as described herein.

II. Computing Environment Delivery Service

The following description is intended to convey a thorough understanding of the embodiments described by providing a number of specific exemplary embodiments and details involving systems and methods for providing computing environment delivery service with offline operations. It should be appreciated, however, that the present disclosure is not limited to these specific embodiments and details, which are exemplary only. It is further understood that one possessing ordinary skill in the art, in light of known systems and methods, would appreciate the use of the disclosed embodiments for the intended purposes and benefits in various embodiments, depending on specific design and other needs. The computing environment delivery service systems and methods may integrate with the software distribution systems as set forth in section I, or function with other software distribution systems and/or methods and any available hardware.

The exemplary computing environment delivery service may be a cloud based device management and provisioning system that may be, by design, both hardware and operating system agnostic. The computing environment delivery service may dramatically simplify the complexities involved in provisioning, deploying, updating, migrating, managing, backing, and restoring computing assets in medium to large enterprise environments for both administrators and end user roles. This may be accomplished in part by unifying every desktop into the cloud using bidirectional synchronization caching from each endpoint computing device. Bidirectional synchronization may provide administrators with the ability to patch, update, and/or migrate all endpoint desktops from a single authoritative source while simultaneously providing a high performance end user experience by processing locally on each endpoint device.

The computing environment delivery service may store all machine operating systems and files for an entire enterprise in one single instance store (SIS) located in a cloud server. SIS may decrease the number of files and bits stored by an inversely proportional amount to the number of machines being managed which dramatically decreases the amount of server disk space needed. The SIS may be divided into logical layers called Cloud Drives and synchronized with managed desktops bi-directionally.

The computing environment delivery service system may execute local cached files and utilize processing and disk resources on local hardware. Executing local cached files and/or utilizing processing and disk recourses on local hardware may increase performance of end user applications and decrease costs associate with data center computing resources. Accordingly, local hardware may perform as an unmanaged machine while online or offline but with the benefits of automatically synchronized updates, migrations, restoration, and/or management when the machine comes online.

The computing environment delivery service may provide extreme network optimization even over wide area networks (WAN) through heavy usage of file single instance stores, variable length file block chunking, understanding and re-usage of local file bits of same or related operating system loads, and/or knowledge of close proximity clients with available resources that act as fast repeater libraries.

The computing environment delivery service may be a multi-tiered cloud based system consisting of 3 basic component groupings. Cloud Components may include, Load Balanced Cloud Servers, SmartDeploy Cloud Service, SQL Database, Cloud Drive—File Single Instance Store (SIS), Cloud Drive—File Block Variable Length Chunks Single Instance Store, Cloud Drive—Logical Layers, Point in Time Archive System, Cloud Administrative Dashboard Application, Cloud User Dashboard Application and/or other viable components.

Client Components may include Agent Service, SQL Database, File System (Filter) Driver, System Configuration Filter Driver, OS Boot Pre-Boot Exchanger Application, Expanded Cloud Drive Bi-directional Cache, Bare-Metal Installation Boot-Strapper, User Dashboard/Tray Application, and/or other viable components.

Mobile Client Components may include Mobile Data Access Application, Mobile Cloud Application, RDP Application for Mobile Execution of Desktop OS (optionally Third Party), and/or other viable components.

The systems and methods may provide cloud based Computing environment delivery service functionality. Full back-up and point in time restoration may be included in the system management feature set. This may include the ability to restore a classroom or lab machine to a specified configuration and remove unspecified or user created files.

The systems and methods may provide user state migration capabilities as well as Operating System and application management. The systems and methods may provide operating system migration capabilities. The systems and methods may provide end point device management from a centralized cloud based location. The systems and methods may provide fast and efficient migrations with a goal of getting the user reengaged in work in approximately 10 minutes or less with minimum applications, such as email or browser. The systems and methods may attempt to reduce cloud storage and bandwidth utilization as much as possible in an effort to minimize cloud services related costs. The systems and methods interfaces and process may be developed in such a way that it may be extremely easy for administrators and users to manage, migrate, and restore devices. The systems and methods may provide remote mobile access, system management capabilities, and file retrieval functionality. The systems and methods may be architected in such a manner that sister components could be developed or compiled in future versions to support devices in addition to Windows based machines such as Mac OSX, iOS, Android, and the like. Client side components may avoid heavy dependence on OS specific technologies when those dependencies may cause a significant divergence in the overall architecture when compared to other OS implementations of the system.

The computing environment delivery service may be a high performance, OS and hardware agnostic, cloud based, enterprise desktop management system complete with centralized updates, single instance storage, bare-metal provisioning, migration, backup, point in time restoration, inventory, software compliance, mobile support, and reporting. The system requires relatively minimal server resources and administration.

The computing environment delivery service may be by design a cross platform system with comparable client and mobile applications on OSX and Microsoft Windows XP or newer operating systems. The minimum processor, memory, and disk space requirements are less than or equivalent to the corresponding hardware requirements of the host operating system.

The computing environment delivery service server components may run on any server, such as, for example, a Microsoft Windows Server 2008 R2 with .Net 4.0+, Microsoft Windows Azure cloud server, Unix or Linux server, or any other viable type of server. The SmartDeploy Computing environment delivery service mobile components may support iOS, Windows, Android, and/or any other mobile operating systems. The minimum hardware requirements may optionally be less than or equal to the corresponding host operating system requirements.

The systems and methods may function with a number of other systems, for example and not by way of limitation, Windows Vista+, Microsoft Visual Studio 2012, Latest Windows Driver Kit (WDK), .NET Framework 4.5, IIS 7.0 (with ASP.NET and WCF HTTP Activation), Microsoft SQL Server 2008, Windows PowerShell (optional), Windows Azure Tools for Microsoft Visual Studio, Latest Driver Development Kit (DDK), Mac OS, Unix, Linux, and/or any other viable hardware or software components.

The computing environment delivery service system interfaces and documentation may be available by default in English with localization support. There may be a possibility of utilizing open source components to meet certain requirements. In this case open source crediting and source compliance may be needed.

The systems and methods may use encryption. SmartDeploy Computing environment delivery service may use the HTTPS protocol for downloading, streaming, and accessing cloud based applications. Optionally PXE may be used for booting bare-metal installations. RDP may also be utilized by mobile or diskless devices to access dynamically generated Cloud Drive device instances.

The computing environment delivery service may include web based, use cases, support documentation, and forum support.

System features are organized by use cases and functional hierarchy so that the main functions of the system may be understandable. In the description of system features there are several references in various system interfaces.

In an example embodiment, the systems and methods may execute the following steps.

Bare Metal Installation

When a computing environment delivery service managed endpoint computing device is lost, damaged, and/or replaced a bare-metal installation may be required if the new device hard drive does not contain an operating system capable of connecting to the internet. In this case, a user may create boot media (USB, DVD, CD) from any internet-enabled device capable of creating the desired media type and then boot the device from the created media. The boot environment may download the minimum OS boot content and user priority files and may stage the file system with missing files marked as offline. The minimum files and configuration settings may download and install in a short amount of time, such as, for example, approximately 10 minutes, and then reboot into the new OS. The user may then begin to use the OS and applications while the remaining files and configuration settings download in the background. Requested files that are yet to be downloaded and are currently unavailable may be re-prioritized and streamed from the cloud server upon demand. This process may enable users to easily provision a bare-metal system to a user functional state.

A computing environment delivery service registered user may create an authenticated bare-metal boot media creation request to the cloud service via a computing environment delivery service may include client dashboard, cloud web application, and/or mobile application. The user may select a target media, and answers a plurality of questions about whether or not the target device may be a new device and, if so, whether or not computing environment delivery service may provision the new device without first backing it up. Because a new device may have a new hard drive that may include a generic or OEM operating system on it, computing environment delivery service may only backup and create a restore point for the OEM operating system if requested to do so during the media creation or by default if specified in the system configuration by an administrator and/or other profile. The computing environment delivery service cloud Service may respond with the boot media download stream of the boot media builder application or boot image. The user boots the endpoint computing device from the computing environment delivery service boot media or PXE. No further interaction may be required from the user.

The computing environment delivery service pre-boot mini-OS environment with https support may load from the boot media and launches the computing environment delivery service pre-boot agent.

The pre-boot agent may authenticate to the cloud server and submit hardware/device ID information. The endpoint computing device may be not recognized by the cloud server and if the administrators have configured the system to pre-inventory all new devices, then a request may be submitted to the administrator to accept the inventory addition request. The request may be approved via one of the standard administrative interfaces. The process may continue if the pre-boot agent may be still running. The machine inventory addition request may be denied by the administrator and the pre-boot agent may display the error message. The provisioning process may then end.

The pre-boot agent may request a bare-metal provisioning instruction set. The instruction set may be pre-calculated by the cloud service based on the user account, machine identification, hardware, and/or department.

The pre-boot agent may execute the provisioning instruction set and download the minimum OS boot files, client agent service, and/or user priority files. The files may download in priority order using de-duplication technology from the cloud server and/or close proximity repeaters. De-duplication technology and/or close proximity repeaters may include any devices on local networks running the computing environment delivery service client agent with available processing resources that contains file or file chunks requested by the instruction set. For other examples, see the Optimized Download Streaming Section.

The computing environment delivery service pre-boot agent may configure the endpoint computing device to boot from the new minimum OS boot files. The pre-boot agent may then reboot the device.

In an example embodiment, the computing environment delivery service may execute a Client OS Pre-Boot Exchanger by executing a number of steps. The endpoint computing device may boot from a minimum boot set which contains enough files and configuration settings from the Base and Hardware layers for the device to boot and connect to the network. The minimum boot set may also include a client agent and dynamically maintained user priority files. In addition the system may contain a modified file system where all files from each layer are file system present but marked offline until downloaded or streamed on access.

After the endpoint computing device has booted from the new OS boot set and accessed the network, the computing environment delivery service client agent may continue to download the remaining missing content from all layer in priority order using network bandwidth optimized techniques documented in the Optimized Download Streaming section.

The user may be able to use the endpoint computing device in approximately 10 minutes (after the minimum boot set may be downloaded and running) while full provisioning process may continue for several hours in a nonintrusive manner to the end user.

The computing environment delivery service client agent may provide the user with progress and status throughout the process via the client dashboard or tray application. The same status may also be available via the cloud user interface and/or the computing environment delivery service mobile application.

The computing environment delivery service system may encompass a client endpoint file system filter driver that may provide the overall system with the ability to stream files and configuration changes to the cloud using optimized bandwidth reducing techniques. For example, see the Client Filter Driver section and the Optimized Download Streaming section. The computing environment delivery service client agent may receive and process file system changes and post file and configuration change logging requests to the cloud service for integration into the user logical layers. When a user is offline the change requests may be stored in a local SQL database and processed as transactions when internet based cloud resources become available.

A computing environment delivery service user may request an endpoint device Point in Time restoration via the dashboard, cloud, and/or mobile interfaces whenever the device has access to internet cloud resources. A user may continue to work as the computing environment delivery service client agent stages the restoration in the background. By way of example, a point-in-time restoration may support a full restoration scenario needed in classroom and/or lab environments where superfluous files and configuration settings are removed during frequent point-in-time restorations on these types of devices.

A computing environment delivery service administrator may request a logical layer migration via the administrative dashboard, cloud, and/or mobile interfaces and target all endpoint devices that are running affected layers. An administrator also may request a logical layer migration and select additional devices to migrate to a new base or department layer. For example, see the Administrator Layer Updates and Migrations section.

The restoration/migration processes may use many of the same components and/or optimization techniques as the bare-metal installation process. The restoration/migration processes may provide functionality for a user to perform a hardware agnostic restoration/migration to the same and/or new device and resume working again in relatively little time.

The restoration/migration process may function by providing a number of steps. A computing environment delivery service registered user may make an authenticated point-in-time request to the cloud service via a computing environment delivery service client dashboard, cloud web application, and/or mobile application. The user may select the desired restoration point and the system may confirm the selection. The point-in-time selections may be grouped into interval points-in-time by hour, day, month, and/or year. For example, see the Point-in-Time Archive System section for further details.

The computing environment delivery service client agent may receive the set restoration instructions and begin processing the individual download instructions in a priority order which may be maintained by the cloud service and/or database. For example, see the section on User File Access Blueprinting and Priorities.

The computing environment delivery service client agent may provide the user with progress and/or status updates throughout the point-in-time restoration process via the client dashboard, cloud interface, and/or computing environment delivery service mobile application.

A computing environment delivery service administrator may make an authenticated migration request to the cloud service via a computing environment delivery service admin dashboard, cloud web application, and/or mobile application. The administrator may select, for example, the “migrate from” and “migrate to” logical layers to confirm the migration.

The computing environment delivery service client agents currently running the selected “migrate from” layer may automatically receive the migration instruction set and begin processing the download instructions in priority order which may be maintained by the cloud service and/or database. For example, see the section on User File Access Blueprinting and Priorities. Client agents may be network bandwidth aware and may delay the processing of instruction sets until network latency rates are acceptable.

The computing environment delivery service client agent may provide the administrator with progress and/or status updates throughout the migration process via, for example, an administrative dashboard, cloud interface, and/or computing environment delivery service mobile application.

If the user requests to restore only individual files (from, for example, a user logical layer) and those selected files are not currently locked by the operating system, the computing environment delivery service client agent may download the selected file(s) to their proper location(s) and notify the user. Upon user notification, the restoration process may end.

If the user requested to restore only individual files (from, for example, a user logical layer) but one or more of those files are locked by running processes, the client agent may stage the locked files. After the file downloads are complete the client agent may prompt the user to allow a reboot. The device may reboot automatically if the device is not in use after a default or administrator configured number of minutes.

Warm Layer Exchanger

Upon reboot, the warm layer exchanger process may complete the restoration instructions set during the boot process prior to the OS file access by moving the selected file(s) to their proper location(s), finishes booting the operating system, and/or notifying the user. The restoration process may end.

The computing environment delivery service warm layer exchanger may comprise an executable that may be configured to load prior to the operating system kernel loading of OS files. The exchanger process may be responsible for processing pre-boot instruction sets. Pre-boot instruction sets may contain directives for updating operating system locked files, updating operating system configuration settings, and/or migrating to new layers.

The pre-boot exchanger executable may load during the initial post of the boot process and may check the staging area of the physical disk for a pre-boot instruction set. If the pre-boot exchanger executable locates a pre-boot instruction set, it may begin to process the instructions in a priority order. Otherwise, the pre-boot exchanger may close and the operating system boot may continue as normal.

The computing environment delivery service pre-boot exchanger executable may process the highest priority instruction. If the instruction is a file replace operation, then the pre-boot exchanger may move the file and/or file chunk from a staging area to a target location and may update the file and set the file attributes, ACLs, and/or properties. The pre-boot exchanger also may mark the file system indicator as online. The instruction may be marked as complete and may be logged by the client agent after the operating system boots. This process may repeat until all pre-boot instructions have been processed. Once the instruction set is complete, the boot pre-boot exchanger may reboot into the endpoint computing device normally and the warm layer exchanger process may complete.

If during the point-in-time restoration request a user selects a full point-in-time restoration and/or the administrator selects a base or department layer migration, the computing environment delivery service client agent may continue to process the instruction set in the background in priority order using network bandwidth optimization techniques document in the Optimized Download Streaming section. First priority files may include, for example, the minimum OS boot set, file system metadata, and/or user priority files. The appropriate logical hardware layer that coincides with the target endpoint device may be included in the restoration even if the hardware differs from the original restoration point in time hardware. This ensures that the restoration may be hardware agnostic and allow restorations to of existing configurations to new and/or upgraded endpoint computing devices. Many of the files may already be available on the local machine further reducing the restoration time. On a full restoration, local device files that are not specified in the point-in-time instruction set may be removed from the local device but may be restored later if they were not excluded from backups. This functionality may be extremely useful, for example, in lab and/or classroom environments where devices need to be regularly restored to a specific configuration.

While downloading the priority set, the client agent may stage the restoration and/or migration files, configuration, and/or file system for the warm layer exchange process to transition the current endpoint configuration to the selected point in time restoration configuration. After a priority boot set has been download and staged the client agent may prompt the user to allow a reboot which may continue automatically in a default or administrator configured number of minutes if the device may be not currently in use. After a reboot, the warm layer exchanger process may complete the restoration and/or migration instruction set during the boot process prior to the OS file access. The warm later exchange process also may move the selected files and configurations to their proper locations.

From this point on the process may use the same corresponding processes and components as the Bare-Metal Installation process found in the Bare-Metal Installation section. The endpoint computing device may boot from the minimum boot set which contains enough files and configuration settings from the Base and Hardware layers for the device to boot and connect to the network. The minimum boot set also may include the client agent and/or dynamically maintained user priority files. In addition, the system may contain a modified file system where all files from each layer are file system present but marked as offline until downloaded and/or streamed on access. For example, see the User File Access Blueprinting and Priorities section.

After the endpoint computing device has booted from the new OS boot set and accessed the network, the computing environment delivery service client agent may continue to download the remaining missing restoration and/or migration content from all layers in priority order using network bandwidth optimized techniques documented in the Optimized Download Streaming section.

The user may be able to use the endpoint computing device in a short amount of time, such as, for example, approximately 10 minutes from restoration and/or migration request. A full restoration process may continue for several hours in a non-intrusive manner to the user.

If the endpoint computing device has less physical disk space than the previous device and may not accommodate all files, the computing environment delivery service client service may leave the least priority file set in the cloud drive and mark the corresponding file system file indicator as offline. If at any time the user desires to access an offline low priority file, the offline file may be streamed down on demand using the process outlined in the Optimized Download Streaming section. In addition, a client agent may mark offline and remove one or more local files of the lowest usage and/or priority if necessary to reclaim enough space for the requested file(s). Removed files can be seamlessly requested and downloaded again if and/or when needed.

The computing environment delivery service client agent may provide the user with progress and/or status throughout the process via a client dashboard and/or tray application. The same status data also may be available via a cloud user web application and/or computing environment delivery service mobile application interfaces. The systems and methods may provide user point in time restoration & admin updates/migrations process flow.

Optimized Download Streaming

Computing environment delivery service may manage endpoint devices and process download requests and/or instruction sets in such a way that network bandwidth utilization may be minimized. While working through a download instruction set and/or list, the computing environment delivery service client agent may use a global unique hashing index code included in the instruction set to efficiently locate an optimal source for retrieving the file or file chunk data. This index code also may be used in a Cloud Drive Single Instance Store and/or a Cloud SQL Database. Many times the file data may already exist on a local machine in a target location and/or other location. For example, if a user is migrating to a new logical base or department layer, the majority of the files needed may already exist on the current endpoint computing device and may be repurposed.

If the file is not available on the local device, a client agent may query close proximity computing environment delivery service managed devices on the local LAN. A client agent may execute a query if the network latency and/or download rates result in faster download and/or streaming speeds. In this way, each computing environment delivery service client service may act as repeater libraries when processing resources available on a repeater client endpoint device. Computing environment delivery service client agents may maintain a contact list of close proximity client repeaters as well their file hash indexes. Maintaining a contact list of close proximity client repeaters may allow for an efficient streaming of data, especially for wide area networks with potentially slow or latent internet connections.

In addition, the computing environment delivery service client agent may use variable length file chunking to minimize the amount of file data sent over the band. For example, if a user has large document and inadvertently deleted a couple of pages, the user may make a single file point-in-time restoration request for the document and only the file data (chunks) resulting in the missing data would be requested over the network resulting in a high performing restoration with low network resource utilization.

Finally, all computing environment delivery service data sent over the network may be compressed for further optimization. A compression may result in an extremely efficient endpoint installation and migration process. For example, an average endpoint device desktop could contain 5 to 60 gigabytes of file data or more. If an endpoint computing device is connected to the internet with a 1.5 Mbps connection, the download speed would be roughly 1 GB per 1.5 hours. Without the computing environment delivery service optimized download streaming, a system may require a minimum of 15 hours to for a user to download and restore a 10 GB desktop. A computing environment delivery service download process may enable a user to restore and endpoint device to an operable system in minutes by downloading needed components, such as an operating system and needed application, in a prioritized manner, allowing rarely used content continues to stream to the device in the background over many hours. The systems and methods may provide an optimized download streaming process functions. A computing environment delivery service client agent may begin processing a file download instruction set in file priority order. File metadata, hash index, and/or priority order may be included in the instruction set.

The computing environment delivery service client agent may attempt to locate a requested file or file chunk from the most efficient source available in an effort to reduce the bandwidth utilization and network latency. For example, a client agent may query the client side SQL data store with the unique hash index code of the current file and/or file chunk to determine if the local device and/or a close proximity repeater already maintain the file data needed. If the file is not available locally but may be available from one or more close proximity repeaters, the query may return the stream location of the for the proximity repeater with the lowest latency, highest ping rate, and/or lowest processor utilization. If the file or file chunk is not available locally or from a close proximity repeater, the client agent may retrieve the file from the computing environment delivery service cloud drive.

The computing environment delivery service client agent may download the requested file or file chunk and from a close source located in the previous step. If the file is a user logical layer file and not currently locked, the client agent may update the file in place and/or sets its attributes, update Access Control List (ACL) properties, mark the file system indicator as online, and/or update a local SQL data store. Otherwise, if the file is a base layer file, the client agent may stage the file in a staging area for exchange during a pre-boot process and create a pre-boot instruction set for the pre-boot exchanger executable to execute against. For example, see the Warm Layer Exchanger section.

The computing environment delivery service client agent may post a progress logging request to the local SQL data store and/or the cloud service to make status available to user and/or administrators. If anytime during this process a user file access request is made for a file that is marked offline in the OS file system, the user file request may move to the front of the queue as highest priority. The current streaming process also may pause and the user access request may instantiate this streaming process against the user requested file or file chunk. This may provide real-time access to files that have not yet synchronized from the authoritative computing environment delivery service cloud drive source.

The computing environment delivery service client agent may repeat this process until all instruction set files and file chunks have been downloaded and/or each time a user priority file access request is made.

Physical Disk Space Reclamation

During computing environment delivery service updates, migrations, and/or point-in-time restorations, a client endpoint computing device may or may not contain enough physical disk space to accommodate all files in all images that are target for the specified device. For example, a user may migrate to a different device with less disk space. Additionally, a user disk drive may be loaded with user-related content and an administrator my request to update a base image with a large service pack or a number of files that may require more physical disk space than available on endpoint computing device.

The computing environment delivery service client agent and filter driver may handle this problem by recognizes that the authoritative source for any file may be a cloud drive location. A computing environment delivery service Filter Driver may simply mark a number of low priority user logical layer files as offline and remove the file bits from the physical disk. A user may select to access the offline files and the offline files may be reprioritized and streamed down to the local environment. This process may repeat if necessary.

The client agent service may monitor and perform physical disk space reclamation in the background and on an ongoing basis to ensure that the endpoint computing device is ready to receive updates, migrations, and/or restorations. Monitoring and preforming physical disk space reclamation may streamline restoration processes and provide a better end user experience by providing a system with enough storage to perform required and/or desired processes. Computing environment delivery service cloud drive may be an authoritative source for all endpoint device files. A rarely accessed file may be removed from an endpoint device in an effort to reclaim disk space. A removed file may be available from the cloud drive.

The user file access patterns may be cached in the local SQL database and synchronized to the computing environment delivery service cloud SQL Database. For example, see User File Access Blueprinting and Priorities section.

User File Access Blueprinting and Priorities

The computing environment delivery service client agent and filter driver may dynamically maintain a user file access blueprint and/or priority list on a managed endpoint computing device. A user file access blueprint may include data indicative of hardware and/or software files that are most recently and/or most frequently accessed. A priority list may include a priority value associated with a hardware and/or software file. A priority value may be based on a frequency of access associated with a file. As a user accesses a file or program directly or indirectly the filter driver may provide data to the client agent for blueprint processing, caching, and/or synchronization. User file access pattern blueprints may be cached in a local SQL database and/or synchronized to the computing environment delivery service cloud service. User file access pattern blueprints may be cached and/or synchronized in a computing environment delivery service cloud SQL Database. Access patterns may be used to dynamically generate and/or maintain a user file priority list and/or order. A dynamic user priority list and/or blueprint may allow a computing environment delivery service to predict which files and/or applications a user may need. This streamlines the installation and migration processes as it dramatically reduces the number of files that need to be downloaded and installed before the user may use the device. It also promotes a hardware agnostic environment in that a user can restore to a device with less disk space. For example, see section on Physical Disk Space Reclamation.

Administrator Layer Updates and Migrations

The computing environment delivery service system may provide a web-based interface into the cloud service that may be accessible from any browser as well as the computing environment delivery service mobile interfaces. The layer updates user interfaces may provide a mechanism for administrators to manage base and/or department logical layers. In addition, an administrator may be able to target and/or deploy one or even a group of endpoint computing devices to receive an operating system update through via a logical layer update. The interfaces may also identify an existing device or virtual machine as a base and/or department layer source device.

Cloud servers available through one or more chosen providers may be loaded with computing environment delivery service components to provide services to any device connected to the internet and associated with a computing environment delivery service registered (enterprise) customer. Example cloud service providers include, for example, Microsoft Azure, Amazon EC2, Google App Engine, RackSpace, GoGrid, OpSource, and the like.

When selecting a cloud service provider, a number of factors may be considered. For example, applicant performance requirements and statistics, application archiving needs and server archiving capabilities, application authentication needs and server authentication offerings, application and system scalability, application third party component requirements and compatibility with server, server automation and provisioning capabilities, server backup and restoration capabilities, server caching capabilities and performance, server charging model, server configuration capabilities, server data access offerings, server data encryption offerings, server data partitioning offerings, server data storage and transaction capabilities, server import and export offerings, server load balancing performance and capabilities, server logging and diagnostics offerings, server network performance and latency, server reporting capabilities, server security, server service level agreements (SLA) for availability, performance, server SQL offerings, server service and batch job capabilities, and/or any other viable criteria.

The computing environment delivery service cloud service may be one or more Windows-based services running on one or more cloud servers and exposing http web interfaces. These interfaces may allow communication requests over standard internet protocols from users or client devices that are registered and/or associated with computing environment delivery service registered accounts. Example service requests may include authentication, device provisioning, management, scheduling, reporting, logging, back-up, restoration, administration, and/or other system management related requests. In addition, the cloud service interacts with a SQL database to store and/or retrieve scheduling, customer, device, file metadata, and/or all other system related settings and data. The cloud service system maintenance subroutines may run as scheduled by default and as requested by administrators to maintain overall system data integrity.

The cloud service may be also responsible for maintaining the file single instance store (SIS), Logical Layers, scheduling management activities, client device compliance management, monitoring overall system performance, provisioning progress, license management, and/or reporting.

A computing environment delivery service registered user\device may make an authenticated provisioning request to the cloud service. The request may be user, admin, and/or cloud service instigated based on compliance management settings. A user instigated provisioning request may then be sent from any internet-enabled web browser, the client agent dashboard, and/or computing environment delivery service mobile application.

The computing environment delivery service cloud service may perform a lookup against the SQL database to retrieve the logical layer information and/or instruction set associated with the account/device request. The logical layers and instruction set may be determined by a number of factors including management rules, hardware, user account, department, user usage priorities, and/or endpoint device information. Computing environment client agents may make scheduled hardware logging requests to the cloud service to update a SQL database with accurate and/or updated hardware metadata and identification information. Logging requests may be scheduled at a predefined times, such as every thirty seconds, every minute, every half-hour, every hour, every other hour, or any other predefined interval.

The cloud service may return a pre-calculated instruction set to the requesting client agent service. A pre-calculated instruction set may include a dynamic minimum boot set, logical layer files, file hashing/indexing data, file and/or file system metadata, configuration settings, user priority content, and/or download priority information.

The client agent may request a user priority file stream on access if bits of the file are not available on the endpoint computing device. The cloud service or local repeater client may respond to a request with the file or file chunk stream data. The client service or local repeater may update a SQL database with the user file request information. Request data may be mined to generate a user filed request pattern. For example, the number of file requests may indicate a pattern of usage with the file. A system may usage data as user specific priority data. For example, see the User File Access Blueprinting and Priorities section.

The computing environment delivery service client agent and/or pre-OS components may perform authenticated provisioning and instruct progress logging requests to the cloud server throughout the provisioning process.

The cloud server may update a SQL database with progress data. The cloud server may make individual device and/or overall enterprise device and/or compliance progress and/or statistics available through administrative cloud reports, dashboard, and/or computing environment delivery service mobile applications. Similarly, user specific device progress, status, and/or compliance reports may be available to associated users via the same outlets. This may allow a user to provision a device remotely as long as the client agent is active on the endpoint computing device.

A cloud service may have a number of cloud service sub-components, such as cloud service authentication, a cloud drive logical layer manager, and/or a cloud drive to virtual desktop infrastructure (VDI) image assembler.

Cloud Drive to VDI Image Assembler

The cloud drive to VDI image assemblers may support mobile users who need full access to a desktop from a remote location and/or possibly even a borrowed device such as a kiosk, tablet, and/or smart phone. Upon request via one of the computing environment delivery service cloud interfaces, the cloud drive to VDI image assembler may create and mount user specific virtual hard drive image which may be a real-time clone of the existing user desktop logical layers. The computing environment delivery service Cloud Service may make the temporary virtual machine available over the internet where an authenticated user with a Remote Desktop Protocol (RDP) appliances, kiosk, tablet and/or smart phone can log in, perform tasks, and/or log out.

The virtual desktop may bi-directionally sync with the cloud drive in exactly the same way that the user's local device may be synchronized. This may enable the user to create documents and make changes that are automatically propagated and available on a user's local device.

After the user logs out of the virtual desktop, the computing environment delivery service cloud service may un-mount the temporary desktop image and remove it to free up server disk space.

The systems and methods may port and/or use the RSYNC algorithms to accomplish part of this functionality.

Computing environment delivery service Logical Layers may provide administrators with the ability to maintain and update base layers to ensure device compliance while providing users with the ability to maintain personalization files and/or settings.

The computing environment delivery service cloud service logical layers manager may be responsible for the updating and/or merging of logical layers such as the base and department logical layers. When a base layer is targeted to an endpoint computing device, the logical layers manager may calculate the new resultant layers for the endpoint. If file and/or configuration conflicts are found, the base layer file and/or configuration settings may override user layer configuration settings. This may allow administrators to manage endpoint devices without being changed by users and ensure overall integrity of the base logical layer.

Prior to applying a new base layer to a target endpoint device, an administrator may generate a report to determine the resultant conflicts of the base image migration. In addition, when targeting all and/or a group of endpoint devices, the computing environment delivery service system may be configured to only target devices where conflicts do not exceed a certain number, type, and/or level. For example, a number may be a predefined number, a type may include a software file conflict and/or a hardware file conflict, where a software file conflict may exist where a software file is unable to migrate to an endpoint device and a hardware file conflict may exists where a hardware file is unable to migrate to an endpoint device. A level may be a predefined level associated with a conflict. For example, a conflict where a required hardware file is required for a new base layer, but the hardware file is unable to migrate may be determined to be a high-level conflict. A report may include a report of devices that were not migrated. The report may include conflict details, such as those described above.

The computing environment delivery service SQL database located on a cloud based Windows Azure server may serve as the authoritative source for all endpoint metadata documented throughout the component sections of this document. A computing environment delivery service cloud service may be responsible for interacting with the SQL database.

The computing environment delivery service database may be, for example, a Microsoft Windows Azure SQL cloud-based relational database platform built on SQL server technologies. By way of example, a Windows Azure SQL database may enable simplified provisioning and deployment of relational database solutions to the cloud. A database may also provide enterprise-class availability, scalability, and/or security with the benefits of built-in data protection and self-healing capabilities.

Single Instance Store

One of the responsibilities of the computing environment delivery service cloud service may be to perform file single instance storage of the enterprise cloud drive content. A cloud drive may be a collection of all files and files chunks for every computing environment delivery service managed endpoint desktop and/or point-in-time snapshots in an enterprise.

The computing environment delivery service single instance storage may provide complete de-duplication by storing only one copy of each unique file in the cloud drive for an entire enterprise. Each file may be referenced and indexed globally. An index may be referenced in the cloud SIS and by local endpoint client de-duplication processes which greatly reduce processor utilization for file analysis. A unique file may only require a onetime analysis per enterprise using cryptographic hash functions for generating the global index and reference metadata. All computing environment delivery service components, including the client and server components, may utilize global file indexes to reference and de-duplicate files.

For example, if an endpoint filter driver receives a request for a file that is marked in the file system as offline (not yet downloaded), the filter driver may add a priority file request to the computing environment delivery service client agent queue for the file. A client agent may query the local computing environment delivery service data store using a global index of the file for the closest available file. The client data store may maintain proximity machine network latency data as well as a collection of all file indexes available on machines. If the requested file index is available from a proximity device, it may be requested and downloaded. Otherwise, the file may be requested from the cloud service using the same global file reference index.

In addition, the SIS may store and process common file variable length chunks in the same manner that full files are indexed and processed. This may provide advanced compression over just single file instancing because many files contain similar byte segments that can also be referenced by a single global index over an entire enterprise. Files such as presentation and/or document files are often shared across and enterprise and modified by many people. These documents may be stored once in the computing environment delivery service cloud drive SIS with only the modified file chunk portions requiring additional space. Storing files in this manner may greatly reduce storage space requirements as well as network bandwidth because it drastically reduces the size of downloads to recover any file updates. When a document is updated by a user, the computing environment delivery service filter driver may add a file update request to the client agent and only the modified chunk of the file may be indexed, compressed, and/or transmitted over the network to the authoritative cloud drive SIS. If that file chunk already exists in the cloud drive, only the file chunk global reference index and metadata may be transmitted. Bringing remote files into sync may be accomplished by using, for example, RSYNC algorithms.

The computing environment delivery service file block variable length chunks Single Instance Store may be the authoritative source for all variable length file chunks (byte blocks) that are de-duplicated across an enterprise. The file chunks may be stored and accessed in the same manner as the full files Single Instance Store but may be stored differently. For example, see the Single Instance Store section for details. By way of example, in order to store and/or access file chucks the system may port and/or use RSYNC. These algorithms may be utilized in UNIX based operating systems.

In order to manage physical images from an enterprise perspective, the computing environment delivery service may introduce separately maintained logical layers as opposed to physical layers. The computing environment delivery service Logical Layers may be groupings of file metadata and configuration settings that make up logical software groupings convenient for managing enterprise devices from a single cloud based source while providing the flexibility of departmental changes and software offerings. The computing environment delivery service logical layers may include a dynamic OS minimum boot logical layer, a hardware layer, a base OS, an application layer, an identification layer, a departmental layer, and/or a user layer. The layers may not contain actual files. The logical layers may simply contain file and configuration metadata. The logical layers also may contain overlapping files and configurations. Overlapping files and configurations may be necessary for layers such as a dynamic OS minimum boot logical layer which may contain files from the OS base layer, hardware layer, and/or the identification layer. In the event that a conflict exists between layers the base layers may take precedence. The actual files referenced in each logical layer may reside in the computing environment delivery service single instance store (SIS) which may be the authoritative source for all files across the enterprise. For example, when an administrator updates a base or departmental layer, all devices associated with that layer may be updated thereby automatically providing simplistic enterprise system device management.

The computing environment delivery service dynamic OS minimum boot logical layer may consist of the minimum files needed to boot a device to an operational state at the log-on screen and/or gain access to the network, internet, and/or cloud service. This logical layer may overlap both the OS base layer and the hardware layer as the files and configuration settings required to boot and access network services may be found in both of the OS base and hardware layers. The dynamic OS minimum boot logical layer may be dynamic as it may be created and maintained by the computing environment delivery service system. Computing environment delivery service client filter driver and/or a pre-boot driver may track and/or log all file access throughout the boot process until network connectivity is established and access to the computing environment delivery service cloud service is made. The file log may be converted to a minimum boot layer instruction set and submitted to the computing environment delivery service cloud service by the client agent. In this way the computing environment delivery service system may be able to dynamically create and maintain minimum boot logical layers for each device type. In addition, by way of example, on Windows operating systems computing environment delivery service components may be able to utilize OS prefetch and superfetch trace logs to supplement boot file access data from filter driver. Once the minimum boot logical layer has been created for a device type it may not need to be recreated until a required file and/or configuration setting changes in the corresponding hardware or OS base layer. The minimum boot logical layer may also be recreated if the client filter driver recognizes that additional files are accessed prior to successful cloud service access. The computing environment delivery service client agent may be included in the minimum boot layer to allow the provisioning and management process to continue after boot. The logical layer may not include any temporary, uninstall, or cache files.

The dynamic OS minimum boot logical layer may include the following: all files that have been identified as accessed and/or necessary for the operating system to boot without requiring additional files from the cloud drive; all files required to access and/or interact with the network, internet, and/or the computing environment delivery service cloud service, which may include network and other hardware drivers needed for a specific endpoint to function normally during initial use; and/or VPN related files for accessing a corporate network when user may be working from home or remote location, for example and not by way of limitation, latest version of the computing environment delivery service client agent files, latest version of the computing environment delivery service filter driver files, and/or latest version of the computing environment delivery service OS pre-boot exchanger application files.

Dynamic User Experience Priority Boot Set Logical Layer

The primary purpose of the dynamic user experience priority boot set logical layer may be to provide the user with a normal responsive user experience even during the provisioning processing. The dynamic user experience priority boot set logical layer may include all files that the specific current user may likely access at a specific time, such as, for example, during a normal work day. This dynamic layer may be created and updated for every user in the computing environment delivery service system. The user experience logical layer may be maintained with the help of the filter driver and an ongoing analysis of the historical file access and file time stamp records. The dynamic user experience priority boot set logical layer may be downloaded with the OS minimum boot logical layer directory prior to a migration. Downloading the dynamic user experience priority boot set logical layer directly prior to migration may ensures that a user is able continue working with files and applications that are important to the user immediately after the initial boot of a migration while the provisioning of rarely used files continues in the background. Operating system application usage registries may be utilized in addition to the filter driver logs to determine applications that may be important to the user immediately after the initiation boot of a migration.

The dynamic user experience priority boot set logical layer may include files likely to be accessed by the user based on analysis of recent user file access records and/or files required by department and/or base layer administrators which may not be accessed frequently but are required.

The computing environment delivery service base OS and application layer may consist of all base operating system files, configuration settings, and/or applications required on every device associated with the base layer. Base layers may include an operating system, service packs, antivirus, disk encryption, email, document editing, internet browsers, and/or enterprise required application and/or configuration settings.

An administrator may create a base operating system layer from any physical or virtual machine. After a machine is loaded with all base OS, security, application software, settings, and/or a client agent, a machine may be synchronized and added to a computing environment delivery service system as a base OS layer. To synchronize and add a machine to a computing environment delivery service system as a base OS layer, an administrator may access a computing environment delivery service cloud management administration page from any machine and/or mobile device, specify that the newly added machine as a base operating system layer, and provide a name and/or version for the machine. The hardware layer may automatically be removed from a base logical layer to ensure that it may be hardware agnostic. The new base OS and application layer may be applied to all, groups, and/or individual devices via an administrative application. The new base OS layer also may be set as the default enterprise base OS layer for all new devices that managed by the computing environment delivery service system.

The computing environment delivery service hardware layer may encompass all files and configuration settings required for a specified device hardware to function properly. Every unique endpoint computing device may maintain a logical hardware layer.

An administrator may create hardware layers using the same method as creating a base layer and/or by uploading platform packs into the computing environment delivery service system via an administrative interface. After a hardware layer has been created and associated with one or more device types, a hardware layer may automatically be downloaded and installed for supporting hardware types during bare-metal installations and migrations.

In addition, hardware layers may be created automatically with help from a computing environment delivery service filter driver. For example, on a Windows OS bare-metal installation, when a new hardware type is introduced to the system and no supporting hardware logical layer is found, then all hardware INF files may be downloaded with the dynamic OS minimum boot layer. The INF files may be relatively light weight to download. This downloading may allow the new device operating system plug and play operation to recognize and configure the hardware on first boot. If the OS plug and play system does not active, the client agent may automatically activate an OS plug and play system to ensure that all hardware files are installed properly. In addition, the client agent may attempt to ensure that the network hardware may be installed and working properly in an effort to provide a good user experience to the end user. The computing environment delivery service filter driver may stream down the required binaries (system files) and device files from the computing environment delivery service cloud drive on demand as specified by the INF configuration files that are chosen by the plug and play system. This process may eliminate a need to have all binaries available on the machine and reduce the amount of time necessary to dynamically create a new hardware layer. The new automatically created hardware layer instruction set may be submitted to the computing environment delivery service cloud service and associated with the current device type. Once the hardware layer is created for a specified device type, a need to download all INFs and to perform plug and play operation on future devices of the same time may be eliminated.

The computing environment delivery service identification logical layer may be comprised of a device identification, a network address, user domain credentials, and/or any other operating system licensing and/or unique identifiers for the specified OS and/or user. Each user and/or endpoint computing device combination may automatically generate a unique identification logical layer. When a device is migrated from one device to another the machines ID may be configured to migrate with the Identification layer and/or be overwritten with a new machine identification ID.

The computing environment delivery service department logical layer may be comprised of all department operating system files, configuration settings, and/or applications required on every device associated with the corresponding department. Department layers may likely include operating system tweaks, documents, and/or departmental required application and/or configuration settings.

An administrator may create department layers using the same method as creating a base layer. For example, creating a department layer may comprise loading a virtual or physical machine with a base OS layer and installing all department applications and/or updates. The administrator may use one of the administrative interfaces to mark the current machine as a departmental logical layer. When a VM or machine is marked as a department layer the computing environment delivery service system may automatically generate department layer metadata as the resultant set of files and/or configuration settings after subtracting the machines base, hardware, and/or identification layers. One or more departmental logical layers may be associated with each department. Department layers may automatically be associated with computing environment delivery service managed devices via an administrative interface with the user of wildcard filters against user, device, and/or network metadata.

A computing environment delivery service user applications, data, and configuration layer may be comprised of all additional applications, configuration settings, and/or user files above and beyond the base, hardware, department, and/or identification layers. The user application data and configuration logical layer may be defined automatically by generating the resultant set after subtracting all other logical layers including hardware, OS base, identification, and department logical layers. This generating may include user documents, files, configuration settings, and user installed applications. Administrators can exclude certain files, file types, applications, and/or temporary files based on wildcard filters. Operating system temporary, swap, and/or hibernation files may be excluded by default.

The non-required files logical layer may be comprised of all files on an endpoint device that have not been accessed in more than an administrator configured amount of time. Files included in this logical layer may be marked as offline in the file system of the endpoint device and may not be downloaded unless requested through a file access request. When a file access request is sent, the file associated with the file request may be reprioritized and removed from the non-required logical layer. Accordingly, unnecessary downloading of a file that has not been accessed in more than an administrative configured amount of time may be avoided thereby reducing network bandwidth utilization as well as the amount of physical disk space that may be required on the endpoint computing device.

Point-in-Time Archive System

The computing environment delivery service point-in-time archive system may include an archive of the culmination of all logical layers associated with a given endpoint computing device at a specific point-in-time. As with the logical layers, point-in-time archives may be logical representations of the files and configuration metadata, and the actual files and file blocks may be stored in the authoritative cloud drive single instance store (SIS).

One of the computing environment delivery service client agent responsibilities may be to bi-directionally sync files, configuration settings, and/or file system metadata with the cloud service. The point-in-time archive system may archive data into time slice intervals to provide users with full point-in-time restoration capabilities.

The point-in-time archives may be aggregated into hourly, daily, weekly, monthly, and/or yearly slice intervals. The computing environment delivery service point-in-time archive system may be responsible for maintaining all managed device point-in-time restorations, organizing restorations into supported intervals, and/or purging superfluous point-in-time restorations that are no longer necessary due to the number of restorations already available for a given interval and/or have exceeded the maximum configured archive interval. When files and/or file chunks in the computing environment delivery service single instance store are no longer referenced by any archive, the corresponding files and/or file chunks may automatically be removed by the computing environment delivery service cloud service in an effort to reclaim cloud storage space and reduce cloud storage costs.

An administrator may change the default point-in-time intervals.

The computing environment delivery service cloud administrative dashboard provides access to all user interfaces that allow administrators to perform all administrative functionality in the computing environment delivery service system. It also provides access to all system reports and real-time performance statistics. All interfaces available in the administrative dashboard may also be available in the mobile administrative application interfaces to allow administrators to perform all administrative activities from any internet connected device.

User Dashboard

The computing environment delivery service cloud user dashboard provides and/or displays all statistics related to the current endpoint device including performance related data. The dashboard also provides additional interfaces that provide a user with the ability to request point in time restorations. It also provides access to all endpoint reports and real-time performance statistics related to the current user. All interfaces available in the user dashboard may also be available in the mobile user application interfaces to allow user to perform the same activities from any internet connected device.

The computing environment delivery service client agent service's primary purpose may be to support the execution, management, bi-directional synchronization, and/or real-time on-demand file streaming of a cloud based desktop which may be primarily cached locally for optimal performance and convenience. The computing environment delivery service client agent service may also support bare metal provisioning, point-in-time backups and restorations, hardware migrations, and/or network optimization functionality for its local endpoint as well as for close proximity endpoint computing devices.

De-Duplication

The de-duplication manager of the computing environment delivery service client agent may provide file de-duplication by eliminating the transfer of any file and/or file chunks from the cloud drive that already exist on the local or neighboring device. For example, see the Optimized Download Streaming section for additional details on optimized downloading from neighboring devices. The file chunk de-duplication functionality in computing environment delivery service may be similar to the file de-duplication functionality but provides advanced bandwidth reduction as de-duplication may eliminate the downloading of frequent file fragments that have already been downloaded on the local and/or neighboring devices from different and/or identical files. The file chunk boundaries may be determined by content similarities across all files on the device and may be variable in length. This may enable increased de-duplication over fixed length block de-duplication. During the de-duplication process the file chunks and/or byte patterns may be analyzed and/or stored with a unique index using a cryptographic hash function and/or reference information at a global level against all base and user files in the cloud database. This may eliminate the need to perform processor expensive analysis more than once per file over the entire enterprise.

File and file chunk reference and index data may be cached locally in the computing environment delivery service data store cache to increase speed of the de-duplication process.

File chunks that are not able to de-duplicate may be compressed and/or transmitted to the computing environment delivery service cloud drive. In order to accomplish compression and/or transmission, the system may port and/or use an RSYNC algorithm. These algorithms may be used on UNIX based operating systems.

For each non-excluded file, the systems and methods may generate a cryptographic signature hash (for example, MD4, MD5, Sha1 Sha256). Signatures may contain two hashes, a quickly generated week hash (e.g., MD4) and a secondary complex hash (e.g., Sha256) that may be compared only when a file signature collision occurs.

If the file has never been copied to the cloud drive and/or does not otherwise exist on the cloud drive, the file may be a Base file. The systems and methods may update data store with base file signature, attributes, ACLs, device, and/or location data and copy a compressed instance of the base file to the single instance cloud drive. The systems and methods may update data store with base file signature, attributes, ACLs, device, and/or location data if the file signature is identical to a cloud drive file signature. The systems and methods may update data store with delta file signature, attributes, ACLs, device, and/or location data and copy a compressed instance of the delta file chunk to the single instance cloud drive when a file exists on cloud drive but changes have occurred locally.

The file access ranking manager may be responsible for processing file access requests received by the computing environment delivery service filter driver. The process may rank a file access importance based on frequency of usage and/or store the access request in a local data store, which may be eventually synced to the authoritative cloud database. This historical file access data may be used to provide am overall file download order of every instruction set as well as to maintain the dynamic user experience priority boot set logical layer. For example, see the dynamic user experience priority boot set logical layer section. This process may be also used to generate license requirements and/or application usage pattern reports. For example, see the physical disk space reclamation section for details on how the file access ranking may be utilized to free up space from the local endpoint device by removing files that are never, rarely, and/or infrequently (and/or otherwise categorized based on frequency) accessed while maintain those files in the cloud for on demand access.

An on demand file access request for a program executable may increase the ranking of the parent folder contents of that executable as well as its sub-folder contents and any files associated with its application type by file extension. An on demand file access request for a program may also increase the priority of dependency dynamic link libraries (DLL) required by the requested application, in anticipation that those library files may be needed. For example, if powerpoint.exe was requested by the user all files associated with PowerPoint could increase in rank priority but may not increase to the same priority level as the PowerPoint related files that were accessed in the process of using the application. This ranking may increase the responsiveness of the endpoint device and provides a better end user experience.

Temporary files and files that are excluded by administrator created filters may not be managed, synced, and/or restored. These files may include swap files, hibernation files, temporary directories, and/or files that may be excluded by administrators such as, for example, music files and/or other media files.

The OS event and configuration manager may be responsible for tracking and/or logging operating system events. This tracking and/or logging data may be utilized with other filter driver file access data to help generate the dynamic user experience logical layer and other heuristics related instruction sets required by the computing environment delivery service system. The client service may generate instruction sets and/or logical layer metadata based on the heuristics blueprinting data that may be collected and/or synchronized with the authoritative cloud service during a next synchronization cycle. The client agent may maintains this data and may supplement the existing instruction sets and/or logical layers with additional files and/or remove files when the client agent determines that the priority of a file is no longer necessary. In this way, the computing environment delivery service system may be able to maximize the user experience.

The OS event and configuration manager may record multiple portions of data in an effort to learn and anticipate the end users' needs during a provisioning, migration, and/or restoration process, such as logon events, logoff event, reboot events, application installations and removals, OS configuration changes and/or personalization settings changes (screen resolutions, and the like).

The offline manager may ensure that all file access requests are cached while the machine is offline and unable to contact the computing environment delivery service cloud service. When the machine comes back online, all file and endpoint configuration changes may be synchronized to the cloud drive and all base and department layer IT updates may be propagated to an endpoint device.

In the event that an offline file is requested while the machine may be itself offline, the offline manager may notify the end user of the situation and log the offline file request as a high priority. Once the endpoint computing device has reconnected to the network and cloud service, the download streaming request may be submitted in the background and download the file automatically.

The point-in-time backup and restoration manager may be essentially a full featured cloud-based backup and restoration application that minimizes network utilization. Functionality of the point-in-time backup and restoration manager may include full and differential or delta backups using de-duplication techniques outlined in the de-duplication section of this document. The backup program may be able to perform full backup of the entire endpoint computing device when the device is first introduced into the managed system. This may allow the device to be restored to its original pre-managed state. The backup process may be able to run as a background process without causing negative impact to the user, such as described herein with respect to the user experience. All backup data may be stored on in the authoritative cloud drive single instance storage of the computing environment delivery service system. After completing the initial full back up the application may work with the computing environment delivery service filter driver to backup files in close to real-time as they are modified. For example, the application may backup files every predefined interval, such as every ten seconds, every thirty second, every minute, or the like. Backups may be grouped into logical point-in-time restoration snapshots by hour, day, week, month, and year. The application may be able to restore an endpoint computing device from the cloud drive SIS to any of the previously recorded snapshots for the specified device.

The user experience manager may be responsible for determining if an end user is currently utilizing the endpoint device. The user experience manager may throttle back any low priority download streaming and/or synchronizations that may be occurring simultaneously. This may ensure that the computing environment delivery service components do not negatively affect the end user experience by reducing performance of the endpoint system when performance may be required by the end user. The user experience manager may accomplish this by monitoring various user-invoked events such as mouse, keyboard, and/or other forms of input. In addition, the user experience manager may monitor process and memory availability as indicators to throttle back.

By way of example, on a Windows based OS's the IPGlobalProperties may be utilized in.Net classes for determining current bandwidth availability. These functions may be used in part for determining and/or setting computing environment delivery service throttles.

The client agent file signature and indexer scanner manager may be responsible for scanning the entire endpoint disk(s) and/or generating the unique global signatures and/or index for every file (or file chunk on large random access files). This process may be run once per endpoint device when it may be initially added as a management computing environment delivery service endpoint device. Running this process once may be necessary to enable advance optimization and de-duplication. The endpoint may then be synced with the computing environment delivery service cloud drive to enable its initial point in time restoration point.

Client Filter Driver

The computing environment delivery service client SQL database may be a client side cache of all endpoint related file metadata content in the cloud based parent database. The local database may be maintained by the computing environment delivery service client agent and bi-directionally synchronized with the Computing environment delivery service cloud service. See the client agent and filter driver sections for additional details.

The computing environment delivery service client file system filter driver may be a driver or program that may be inserted into the existing endpoint computing device driver stack to interrupt and/or capture every file access request that occurs, either from the user or from the operating system and/or executing programs.

The filter driver may be responsible for logging all file access requests to the computing environment delivery service client agent which processes, ranks, and/or stores file access heuristics data used by many components and/or reports in the computing environment delivery service system. The file access data may be also used to generate the minimum boot set logical layer, hardware layer, user experience layer, and/or other instruction sets. Because of this, it may be important that the file access capture process start very early in the boot process in order to accurately capture all files needed for minimum boot and hardware layers. Since the minimum boot logical layer may be a dynamic layer, the file access capture process must run during every boot to accurately track changes in files that are required for a given endpoint to fully boot without requiring the download (streaming) of additional files from the computing environment delivery service cloud drive. This may provide a responsive end user experience during a point-in-time restoration or migration process.

In order prevent the inclusion of false positive file access requests (files that were accessed but not really needed), the filter driver may exclude logging of the file access requests made by anti-virus and/or other scanner and/or indexing programs. Accordingly, a filter driver may verify that a file access request program is not on a scanner program blacklist. The blacklist may be modified globally by administrator. In addition, the client agent may update the scanner blacklist when the client agent detects that a process may be requesting file access to many files contiguously. It may be possible to optimize the filter driver file access logging by tracking file access requests in memory where only file rename, create, and/or close operations are logged.

In addition, the filter driver may be responsible for requesting the download of offline files via a client agent when those files are accessed. If offline files are accessed often, that may be an indicator that the filter driver and client agent are not accurately tracking and/or predicting what files may be needed by an end user. However, a user may randomly request access to files that cannot be predicted and may be downloaded from the cloud drive in real-time. To do this, the filter driver virtualizes the endpoint file system by virtually including all of the user's files in the file system but marking files offline that have not been downloaded yet. In this way, files may appear in file explorers and application file queries but may display with an offline indicator. These file may be retrieved in real-time from the computing environment delivery service cloud drive upon request from a user or application call. When this occurs the filter driver may interrupt the file access request and notify the client agent that the offline file has been requested. The computing environment delivery service client agent may send an authenticated file download request to the computing environment delivery service cloud service, downloads the file, and/or update the target endpoint location. The filter driver may mark the file system file setting as online, un-interrupt the calling process, and/or provide the calling process with the requested file handle. Offline file requests may be processed with the highest priority in an effort to maintain a good user experience. For example, see the Optimized Download Streaming section for details.

If a request is made for an offline file that is a large random access file (e.g., a Microsoft Outlook .PST file), the filter driver may perform the same download operation except that only the byte chunk or blocks requested are returned from the cloud service. To return on the byte chuck and/or blocks requested, the filter driver may allow the requesting application to open an offline file stub, interrupts the byte block read requests, and, through the client agent, return the requested chunks from the cloud drive. The filter driver may allow the requesting application to read the data. This process may repeat until either the requesting application has all of the data that may be required or until the file may be completely downloaded. The filter driver and/or client agent may trace all file chunk requests and discontinue the block level interrupts on a file once it has downloaded completely. In order to improve file chunking request performance, the client agent may analyze file chunk requests and patterns for individual files and file types. Using these patterns, additional blocks may be requested with existing block requests of the same file to reduce the number of overall requests that may be required and increase performance for the end user. This data may be also recorded at a global level and utilized across an enterprise to optimize the downloading of logical layers and streaming for all users. Sharing violations may need to be handled by the filter driver when a file or file chunk is interrupted and locked because of a request from one process while another process attempts to make the write on the same file chunk. It may be possible to handle this scenario by modifying the sharing locks to allow both processes access, but then handle the request from the filter driver by ensuring that the block has been fully downloaded from the cloud drive before allowing the chunk write to continue.

If an offline file may be requested while the endpoint device may be not connected to the network or may be without access to the computing environment delivery service Cloud Service then the filter driver may return standard failure code (STATUS_FILE_MAY BE_OFFLINE on Windows OS) to the requesting process which may handle the failure. On Windows operating system the Windows Explorer may display the offline file icon indicator for all files that are marked as offline.

The filter driver or client agent may cause the computing environment delivery service client dashboard or tray icon to display a download streaming notification during offline file download streaming to improve usability and user understanding.

The computing environment delivery service client file system filter driver may not affect the normal working of the existing driver stack in any major way and may be developed in such a way that it does not noticeably degrade the device performance and/or end user experience. Additionally, the filter driver may function regardless of whole disk encryption software that may have been installed on an endpoint computing device.

The computing environment delivery service client file system filter driver responsibilities may include, for example, and not by way of limitation, optimized capture and/or logging of file and/or directory access requests to the client agent, managing offline files, requesting the download of offline files and/or file chunks, managing the virtualization of the endpoint file system into the computing environment delivery service cloud, exclusion of scanner, and/or indexing request logging.

The computing environment delivery service client system configuration filter driver may be similar to the computing environment delivery service client file system filter driver in many ways and possibly developed as the same filter driver. For example, client filter driver may be a driver or program that is inserted into the existing endpoint computing device driver stack to interrupt and capture every file access request that occurs either from the user or from the operating system and/or executing programs. For further information, see the Client Filter Driver section. The configuration filter driver may be primarily responsible for interrupting access request to operating system specific configuration files such as, for example, the Windows Registry related files. The configuration filter driver may track and/or log updates, additions, and/or deletion changes to individual sections of these configuration files at a chunk level, requiring only a file lock on the specific section that may be being updated. This may eliminate the need to lock the entire configuration or registry file. The change log data may be utilized by instruction sets for maintaining logical layers. The change log data also may facilitate low bandwidth synchronization of changes to the authoritative computing environment delivery service cloud drive.

The filter driver may function regardless of whole disk encryption software that has been installed on an endpoint computing device.

The computing environment delivery service client OS pre-boot exchanger application may be a process that may be executed very early in the operating system boot process by hooking into the operating system boot process and loading prior to other OS applications. This application processes may look for file update instruction sets that may have been created by the computing environment delivery service client agent during the beginning of a migration, installation, and/or point-in-time restoration process followed by a reboot. The exchanger application may run prior to other files being accessed and locked. Because of this, the exchange application may be developed as a native application requiring no OS dependencies. The computing environment delivery service exchanger application may be hooked into and/or launched by the session manager from the BootExecute key in the registry on, for example, a Windows based operating systems. This may enable the exchanger application to load first in the boot process as a native application.

One purpose of the client OS pre-boot exchanger application may be to process any local pre-staged instruction sets and/or install or replace files and operating system configuration settings. Files may be moved from the staging directory to the target directory of the local endpoint computing device by the exchanger native application utilizing native file IO APIs. The exchanger may delete files from both staging and target directories when required by the instruction sets. The exchanger application may be required to elevate it permissions as needed in working with restricted files of the endpoint computing device. This early in the boot process, it may be possible for the exchanger to update any file on the device since no file executions and locks have been initiated.

The instruction set may provide all file metadata information necessary for the exchanger application to reconstitute Access Control Lists (ACLs), file attributes, target location, and file short names. By way of example, a Microsoft icacls utility may be utilized to save and restore ACLs.

After completing any instruction, the exchanger application may end the current reboot and perform an in-place reboot which allows the endpoint device to boot from the new operating system files and/or configuration settings.

A full base layer recovery instruction set may be created to download all base image files in the event that an endpoint computing device fails to successfully boot from the minimum boot set logical layer.

The computing environment delivery service client bare-metal installation boot-strapper may be an application that creates and loads a mini OS environment capable of accessing the network and the computing environment delivery service cloud service. A client bare-metal installation boot-strapper process may download and/or stage the minimum OS boot layer.

The computing environment delivery service pre-boot mini-OS environment with http support may load from a boot media and launch the computing environment delivery service pre-boot agent.

The pre-boot agent may authenticate to the cloud server and submit hardware and/or device ID information. If the endpoint computing device is not recognized by the cloud server and if the administrators have configured the system to pre-inventory all new devices, then a request may be submitted to the administrator to accept the inventory addition request. Once the request is approved via one of the standard administrative interfaces, the process may continue if the pre-boot agent may be still running. If the machine inventory addition request is denied by the administrator, the pre-boot agent may display an error message and the provisioning process may end.

The pre-boot agent may request a bare-metal provisioning instruction set. The instruction set may be pre-calculated by the cloud service based on the user account, machine identification, hardware, and/or department.

The pre-boot agent may execute the provisioning instruction set and download the minimum OS boot files, client agent service, and/or user priority files.

The files are downloaded in a priority order using de-duplication technology from the cloud server and/or close proximity repeaters which may be any machine on local networks that are running the computing environment delivery service client, have available processing resources, and contain file and/or file chunks that are requested by the instruction set. For example, see the Optimized Download Streaming Section.

The computing environment delivery service pre-boot agent may configure the endpoint computing device to boot from the new minimum OS boot files. The computing environment delivery service pre-boot agent may then reboot the device. To accomplish a portion of the reboot, the system may port and us RSYNC algorithms.

The computing environment delivery service client user tray application may be a visible indicator icon that the end user may interacted with in order to access the user dashboard application interfaces and/or performance statistics. For example, see the user dashboard section. In addition, the tray application may display a message window indicating the current process being performed. By way of example, a message window may display a notification that an offline file is currently being downloaded.

The computing environment delivery service client mobile data access application may be, for example, an HTML5 and/or mobile device native application that provides an interface for the end user to authenticate to the computing environment delivery service cloud service. After successful authentication, the application may retrieve a file explorer view of all files available to the authenticated user and allow the end user to download and/or open individual files in third party mobile applications. Administrators may be able to block access to this functionality for security purposes.

The computing environment delivery service client mobile cloud application may be, for example, an HTML5 and/or mobile device native application that provides user interfaces to all computing environment delivery service cloud service activities and reports. The user interface and report availability may be limited by system rolls. For example, end user may only have access to the end user endpoint and user related data and reports while administrators may have access to all administrative and management user interfaces.

The computing environment delivery service client mobile RDP application may be a third party application that provides remote desktop access via the standard Remote Desktop Protocol (RDP). The computing environment delivery service may intercepts an authenticated RDP request and dynamically assemble a virtual drive allowing a user to access and control an endpoint desktop from any kiosk and/or mobile device. For example, see the Cloud Drive to VDI Image Assembler section for details.

The computing environment delivery service system may be comprised of a number of user interfaces.

Computing environment delivery service cloud service may require, for example, a Windows Server 2008 R2 server inside a customer enterprise to support Active Directory federation authentication.

A computing environment delivery service system may interface with many libraries and frameworks. Computing environment delivery service may use SSL over TCP/IP for all client server communications. Computing environment delivery service client components may perform IPC locally using shared memory file mapping. Additionally, the computing environment delivery service clients may communicate with close proximity client agents while acting as repeaters using WCF or .Net remoting on, for example, Windows operating systems.

The computing environment delivery service system may provide point in time recovery and OS migrations and allow the user to continue working within minutes under optimal circumstances. The computing environment delivery service system may implement security to ensure data protection and privacy on all system tiers.

The computing environment delivery service client components may support standard third party whole disk encryption software. This may provide protection of all data at the endpoint computing device.

All bi-directional client server synchronization to and from the computing environment delivery service cloud service may be encrypted using standard SSL over TCP/IP. All access to the computing environment delivery service cloud component including the service, cloud drive, and/or database may be protected by federated active directory (AD) authentication of the enterprise customer.

Optionally, for smaller customers, computing environment delivery service may support custom account authentication, such as, for example, Gmail, Windows Live ID, Facebook, and/or other providers for strong authentication.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method, comprising:
delivering, using a file filter driver, a base file system from a client agent to a client device over a computer network;
using one or more computer processors, queuing one or more data items for additional computing functions based on an instruction set, wherein the instruction set includes a data item priority associated with each data item; and
streaming the one or more data items for additional computing functions to a physical disk of the client device according to the priority associated with each data item.

2. The method of claim 1, wherein the data items for additional computing functions include user logical layer files.

3. The method of claim 2, wherein the file filter driver marks at least one data item as low priority, and wherein the low priority data items are marked as offline on the physical disk.

4. The method of claim 3, further comprising transmitting instructions to remove a low priority data item from the physical disk when the low priority data item is marked as offline on the physical disk.

5. The method of claim 3, wherein the low priority data items marked as offline are not streamed to the physical disk of the client device.

6. The method of claim 1, wherein the instruction set further comprises file metadata and a hash index.

7. The method of claim 1, further comprising:
tracking usage data associated with the data items streamed to the physical disk; and
updating the instruction set and the data item priority based on the tracked usage.

8. The method of claim 7, further comprising transmitting instructions to mark data files streamed to the physical disk as offline and remove one or more data files based on the updated instruction set.

9. The method of claim 8, wherein transmitting instructions is based on an alert received from the physical disk, wherein the alert comprises disk storage data.

10. The method of claim 1, further comprising:
receiving updated data associated with at least one of the data files;
performing de-duplication based on the received update data, wherein de-duplication may include generating a hash value for the updated data, searching a client agent index for the hash value, and determining whether the update data exists in the client agent index.

11. The method of claim 10, wherein the updated data is not transferred to the client agent when the de-duplication determines the update data exists in the client agent index.

12. A system, comprising:
a file filter driver configured to deliver a base file system to a client device over a computer network;
a queue module comprising one or more computer processors configured to queue one or more data items for additional computing functions based on an instruction set, wherein the instruction set includes a data item priority associated with each data item; and
a delivery module configured to stream the one or more data items for additional computing functions to a physical disk of the client device according to the priority associated with each data item

13. The system of claim 12, wherein the data items for additional computing functions include user logical layer files.

14. The system of claim 13, wherein the file filter driver marks at least one data item as low priority, and wherein the low priority data items are marked as offline on the physical disk.

15. The system of claim 14, wherein the delivery module is further configured to transmit instructions to remove a low priority data item from the physical disk when the low priority data item is marked as offline on the physical disk.

16. The system of claim 14, wherein the low priority data items marked as offline are not streamed to the physical disk of the client device.

17. The system of claim 12, wherein the instruction set further comprises file metadata and a hash index.

18. The system of claim 12, further comprising a management module configured to track usage data associated with the data items streamed to the physical disk; and update the instruction set and the data item priority based on the tracked usage.

19. The system of claim 18, wherein the management module is further configured to transmit instructions to mark data files streamed to the physical disk as offline and remove one or more data files based on the updated instruction set.

20. The method of claim 19, wherein transmitting instructions is based on an alert received from the physical disk, wherein the alert comprises disk storage data.
